(19) United States
(12) Patent Application Publication
(10) Pub. No.: US 2026/0163962 A1
(43) Pub. Date: Jun. 11, 2026

(54) DATA TRANSFER SCHEDULING

(71) Applicant: Telefonaktiebolaget LM Ericsson (publ), Stockholm (SE)

(72) Inventors: Maheswaran MUTHUCUMARU, Pierrefonds (CA); Olamilekan FADAHUNSI, Mississauga (CA); Emmanuel THEPIE FAPI, Cote-Saint-Luc (CA)

(21) Appl. No.: 18/703,843

(22) PCT Filed: Oct. 27, 2021
(86) PCT No.: PCT/IB2021/059928

§ 371 Date: Apr. 23, 2024

(51) Int. Cl. H04L 67/61; H04L 41/147; H04L 47/28; H04L 67/62; H04W 40/02

(52) U.S. Cl. CPC H04L 67/61; H04L 41/147; H04L 47/28; H04L 67/62; H04W 40/02

(57) ABSTRACT

A computer-implemented method for scheduling a data transfer between a first node and a second node in a network. The first node is a mobile node. The method includes scheduling the data transfer between the first node and the second node based on an expected network condition in the network at each of a plurality of locations along an expected path of the first node in the network.

### TECHNICAL FIELD

The disclosure relates to a computer-implemented method for scheduling a data transfer and an entity configured to operate in accordance with this method.

### BACKGROUND

In some networks (e.g. telecommunications networks, such as fifth generation, 5G, mobile networks), artificial intelligence (AI) and machine learning (ML) tasks that are highly data intensive and require data to be processed within short time limits are generally suitable for edge and fog computing. Edge and fog computing involve a distributed computing and data storage framework that brings data processing closer to the source of the data. Edge and fog computing can, for example, be used for services with low latency requirements to enable ultra-fast interactions and responsiveness.

In edge and fog computing scenarios, nodes are dynamic and resources are unbalanced. The task scheduling strategies that exist for these scenarios need to fully utilise the limited resource available on the edge and fog nodes to increase the executability and resource efficiency of an application. In order to support this resource utilisation, the running status of the application and the dynamic condition of the resource need to be monitored and tracked in real time manner. As the link between an edge/fog node to the network is a critical enabler for edge and fog computing, the true state of the network needs to be considered in scheduling edge and fog computing executions. That is, network-aware scheduling is required. This is particularly important given that variations in network state characteristics can significantly impact the performance expected from edge and fog computing.

FIG. 1 illustrates an example of this issue in an existing system. More specifically, FIG. 1 illustrates an example of network awareness in edge computing versus cloud computing. In the illustrated example, a link takes packets of data from a device (specifically, a vehicle) 200 to a base station 202 of a mobile network. From the base station 202, the packets are transported via an edge server 204 through multiple links to a core network 206, where a cloud server 208 is located. There are two situations illustrated in FIG. 1. The first situation is where the device 200 is in a first zone 210 that has high (e.g. 5G) network coverage and the second situation is where the device 200 is in a second zone 212 that has low (e.g. 5G) network coverage.

As illustrated in FIG. 1, the latency of crossing the link from the edge server 204 to the cloud server 208 of the core network 206 is 25 ms. When the device 200 is in the first zone 210 that has high network coverage, the latency of transmitting packets over the link from the device 200 to the edge server 204 is 5 ms and thus the total end-to-end latency of accessing the cloud server 208 of the core network 206 from the device 200 is 30 ms. On the other hand, when the device 200 is in the second zone 212 that has low network coverage, the latency of transmitting packets over the link from the device 200 to the edge server 204 is 8 ms and thus the total end-to-end latency of accessing the cloud server 208 of the core network 206 from the device 200 is 33 ms.

Therefore, in the device 200 moving from the first zone 210 that has high network coverage to the second zone 212 that has low network coverage, there is about a 60% increase in the latency of transmitting packets over the link from the device 200 to the edge server 204 and about a 10% increase in the total end-to-end latency of accessing the cloud server 208 of the core network 206 from the device 200. It can therefore be seen that the effective performance of edge computing will degrade more from link variation (60%) and less in the cloud scenario (10%).

In order to address the impact that network state characteristics have on an expected computing performance, there have been various techniques developed for network-aware scheduling in cloud environments. There have been very few network-aware scheduling techniques developed in fog and edge computing environments. However, even with the network-aware scheduling techniques that have been developed for these environments, certain issues can exist during task scheduling in such environments, such as slow task completion time, high energy consumption, and unbalanced load.

Wireless mobile telecommunications upgraded to a 5G network enable a new application scenario for edge computing. However, wireless network performance can drop due to electromagnetic interference (e.g. caused by other networks and certain types of equipment), absorption and reflection, multipath fading, hidden node issues, exposed terminal node problems, and shared resource problems. This can have a negative impact on application performance.

### SUMMARY

It is an object of the disclosure to obviate or eliminate at least some of the above-described disadvantages associated with existing techniques.

Therefore, according to an aspect of the disclosure, there is provided computer-implemented method for scheduling a data transfer between a first node and a second node in a network. The first node is a mobile node. The method comprises scheduling the data transfer between the first node and the second node based on an expected network condition in the network at each of a plurality of locations along an expected path of the first node in the network.

According to another aspect of the disclosure, there is provided an entity configured to operate in accordance with the method. In some embodiments, the entity may comprise processing circuitry configured to operate in accordance with the method. In some embodiments, the entity may comprise at least one memory for storing instructions which, when executed by the processing circuitry, cause the entity to operate in accordance with the method.

According to another aspect of the disclosure, there is provided a computer program comprising instructions which, when executed by processing circuitry, cause the processing circuitry to perform the method.

According to another aspect of the disclosure, there is provided a computer program product, embodied on a non-transitory machine-readable medium, comprising instructions which are executable by processing circuitry to cause the processing circuitry to perform the method.

Therefore, there is provided an advantageous technique for scheduling a data transfer between a first node and a second node in a network.

### BRIEF DESCRIPTION OF THE DRAWINGS

For a better understanding of the techniques, and to show how they may be put into effect, reference will now be made, by way of example, to the accompanying drawings, in which:

FIG. 1 is an illustration of an existing system;

FIG. 2 is a block diagram illustrating an entity according to an embodiment;

FIG. 3 is a block diagram illustrating a method performed by the entity according to an embodiment;

FIG. 4 is a schematic illustration of an example of a directed acyclic graph;

FIG. 5 is a schematic illustration of an example network;

FIG. 6 is a schematic illustration of a system according to an embodiment;

FIGS. 7 and 8 are schematic illustrations of methods performed according to some embodiments;

FIG. 9 is an example of a network-aware scheduling (NAS) process according to an embodiment;

FIG. 10 is a schematic illustration of a method performed according to some embodiments;

FIG. 11 is an example of a switching process according to an embodiment;

FIG. 12 is a schematic illustration of directed graphs according to some embodiments;

FIG. 13 is a schematic illustration of a performance map according to an embodiment;

FIG. 14 is an example of a network-unaware scheduling (NUS) process according to an existing technique;

FIGS. 15-17 are graphical illustrations of experimental results of a simulation; and

FIG. 18 is a schematic illustration of a system according to an embodiment.

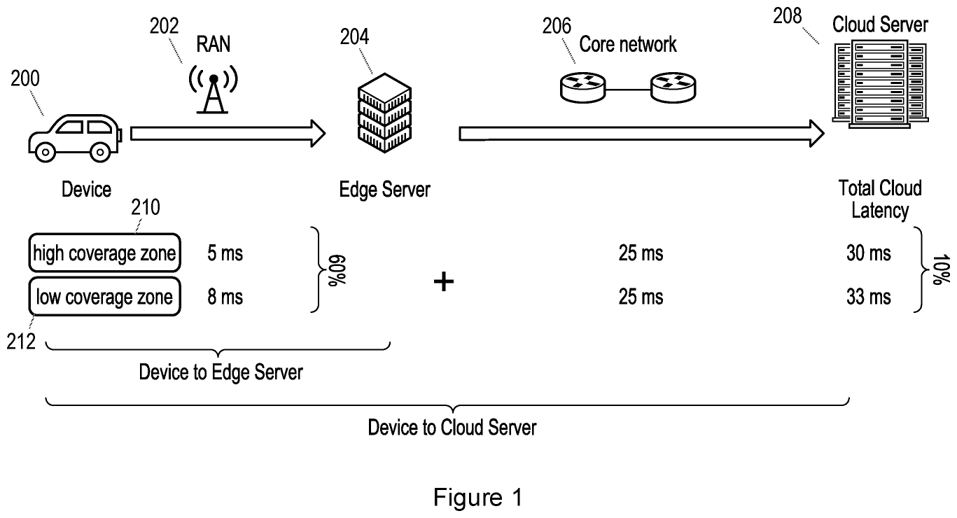

### DETAILED DESCRIPTION

Some of the embodiments contemplated herein will now be described more fully with reference to the accompanying drawings. Other embodiments, however, are contained within the scope of the subject-matter disclosed herein, the disclosed subject-matter should not be construed as limited to only the embodiments set forth herein; rather, these embodiments are provided by way of example to convey the scope of the subject-matter to those skilled in the art.

As mentioned earlier, there is described herein an advantageous technique for scheduling a data transfer between a first node and a second node in a network.

In some embodiments, one or both of the first node referred to herein and the second node referred to herein may be an edge node of the network. In some embodiments, the first node referred to herein and the second node referred to herein can be discrete nodes. In some embodiments, the first node referred to herein may be a device or a smart device (e.g. an Internet of Things, IoT, device, an Industrial Internet of Things, IIoT device, or an edge device), or a vehicle or smart vehicle (e.g. a car or any other vehicle).

In some embodiments, the second node referred to herein may be a server (e.g. an edge server), a base station, or a (e.g. new radio, NR) radio access network (RAN) node. In some embodiments, the first node referred to herein and the second node referred to herein may be components of a fourth node. In some embodiments, the fourth node referred to herein may be a device, a server, or a vehicle. The first node and the second node described herein may communicate with each other over a communication channel. In some embodiments, the first node and the second node described herein may communicate over the cloud.

The network referred to herein can be any type of network. For example, the network referred to herein can be a telecommunications network. In some embodiments, the network referred to herein can be a mobile network, such as a fourth generation (4G) mobile network, a fifth generation (5G) mobile network, a sixth generation (6G) mobile network, or any other generation mobile network. In some embodiments, the network referred to herein can be a radio access network (RAN). In some embodiments, the network referred to herein can be a local network, such as a local area network (LAN).

In some embodiments, the network referred to herein may be a content delivery network (CDN). Although some examples have been provided for the type of network, it will be understood that the network can be or any other type of network. In some embodiments, the network referred to herein can be a fog computing environment or an edge computing environment. In some embodiments, the telecommunications network referred to herein can be a virtual network or an at least partially virtual network.

In some embodiments, the technique described herein can be performed by an entity. The technique described herein can be implemented in the cloud according to some embodiments. The techniques described herein are computer-implemented.

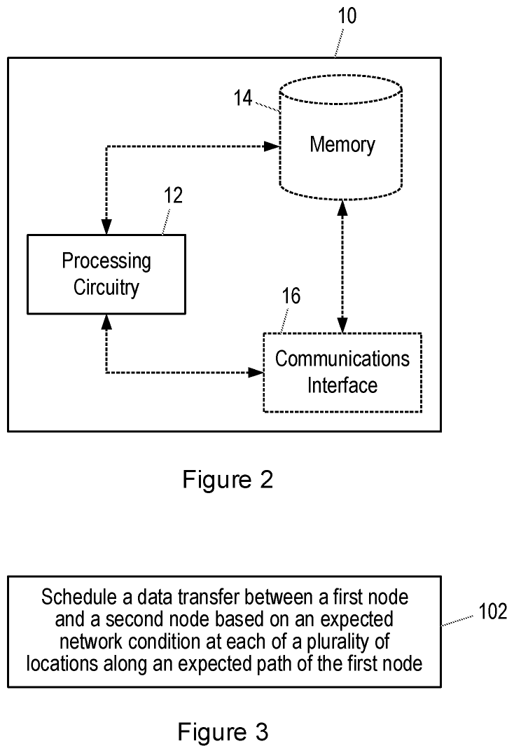

FIG. 2 illustrates an entity 10 in accordance with an embodiment. The entity 10 is for scheduling a data transfer between a first node and a second node in a network. The first node is a mobile node. The entity 10 referred to herein can refer to equipment capable, configured, arranged and/or operable to communicate directly or indirectly with other entities or equipment to enable and/or to perform the functionality described herein. The entity 10 referred to herein may be a physical entity (e.g. a physical machine) or a virtual entity (e.g. a virtual machine, VM).

As illustrated in FIG. 2, the entity 10 comprises processing circuitry (or logic) 12. The processing circuitry 12 controls the operation of the entity 10 and can implement the method described herein in respect of the entity 10. The processing circuitry 12 can be configured or programmed to control the entity 10 in the manner described herein. The processing circuitry 12 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the entity 10. In some embodiments, the processing circuitry 12 can be configured to run software to perform the method described herein in respect of the entity 10. The software may be containerised according to some embodiments. Thus, in some embodiments, the processing circuitry 12 may be configured to run a container to perform the method described herein in respect of the entity 10.

Briefly, the processing circuitry 12 of the entity 10 is configured to schedule the data transfer between the first node and the second node based on an expected network condition in the network at each of a plurality of locations along an expected path of the first node in the network.

As illustrated in FIG. 2, in some embodiments, the entity 10 may optionally comprise a memory 14. The memory 14 of the entity 10 can comprise a volatile memory or a non-volatile memory. In some embodiments, the memory 14 of the entity 10 may comprise a non-transitory media. Examples of the memory 14 of the entity 10 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 12 of the entity 10 can be connected to the memory 14 of the entity 10. In some embodiments, the memory 14 of the entity 10 may be for storing program code or instructions which, when executed by the processing circuitry 12 of the entity 10, cause the entity 10 to operate in the manner described herein in respect of the entity 10. For example, in some embodiments, the memory 14 of the entity 10 may be configured to store program code or instructions that can be executed by the processing circuitry 12 of the entity 10 to cause the entity 10 to operate in accordance with the method described herein in respect of the entity 10. Alternatively or in addition, the memory 14 of the entity 10 can be configured to store any information, data, messages, requests, responses, indications, notifications, signals, or similar, that are described herein. The processing circuitry 12 of the entity 10 may be configured to control the memory 14 of the entity 10 to store information, data, messages, requests, responses, indications, notifications, signals, or similar, that are described herein.

In some embodiments, as illustrated in FIG. 2, the entity 10 may optionally comprise a communications interface 16. The communications interface 16 of the entity 10 can be connected to the processing circuitry 12 of the entity 10 and/or the memory 14 of entity 10. The communications interface 16 of the entity 10 may be operable to allow the processing circuitry 12 of the entity 10 to communicate with the memory 14 of the entity 10 and/or vice versa. Similarly, the communications interface 16 of the entity 10 may be operable to allow the processing circuitry 12 of the entity 10 to communicate with any other entities or nodes referred to herein, such as the first, second, third and/or fourth nodes referred to herein. The communications interface 16 of the entity 10 can be configured to transmit and/or receive information, data, messages, requests, responses, indications, notifications, signals, or similar, that are described herein. In some embodiments, the processing circuitry 12 of the entity 10 may be configured to control the communications interface 16 of the entity 10 to transmit and/or receive information, data, messages, requests, responses, indications, notifications, signals, or similar, that are described herein.

Although the entity 10 is illustrated in FIG. 2 as comprising a single memory 14, it will be appreciated that the entity 10 may comprise at least one memory (i.e. a single memory or a plurality of memories) 14 that operate in the manner described herein. Similarly, although the entity 10 is illustrated in FIG. 2 as comprising a single communications interface 16, it will be appreciated that the entity 10 may comprise at least one communications interface (i.e. a single communications interface or a plurality of communications interface) 16 that operate in the manner described herein. It will also be appreciated that FIG. 2 only shows the components required to illustrate an embodiment of the entity 10 and, in practical implementations, the entity 10 may comprise additional or alternative components to those shown.

FIG. 3 illustrates a method performed by the entity 10 in accordance with an embodiment. The method is computer-implemented. The method is for scheduling a data transfer between a first node and a second node in a network, where the first node is a mobile node. The entity 10 described earlier with reference to FIG. 2 can be configured to operate in accordance with the method of FIG. 3. The method can be performed by or under the control of the processing circuitry 12 of the entity 10 according to some embodiments.

With reference to FIG. 3, as illustrated at block 102, the data transfer between the first node and the second node is scheduled based on an expected network condition (or state) in the network at each of a plurality of locations along an expected path (e.g. trajectory) of the first node in the network. More specifically, the entity 10 (e.g. the processing circuitry 12 of the entity 10) may be configured to schedule the data transfer in this way according to some embodiments.

In some embodiments, the data transfer referred to herein can comprise any one or more of at least one transmission of data from the first node towards the second node and at least one transmission of data from the second node towards the first node. In some embodiments, the data transfer referred to herein can be for executing (e.g. at the first node) an application. In some embodiments, the data transfer referred to herein can be for executing (e.g. at the first node) a set of tasks of the application. In some embodiments, the application may be an application that performs machine learning. In some embodiments, the application may be hosted at a cloud based location, e.g. at a cloud server. In some embodiments, the application (e.g. a specific and/or local application) may be hosted at the second node. The application referred to herein can be an artificial intelligence or machine learning (AI/ML) application or any other application. An AI/ML application may be an application that employs AI/ML in its implementation.

In some embodiments, the expected network condition in the network at each of the plurality of locations may be identified from a dataset. In some embodiments, for each location of the plurality of locations, the dataset may comprise a mapping between the location and the expected network condition at the location. In some embodiments, the dataset may be updated in response to a change in the expected network condition at any one or more of the plurality of locations. In some embodiments, the expected network condition at each of the plurality of locations may be predicted using a machine learning model that is trained to predict a network condition. In some embodiments, the expected network condition at each of the plurality of locations may be predicted based on historical measurements of the network condition at each of the plurality of locations.

In some embodiments, the first node may be configured to measure the network condition at each of the plurality of locations. In some of these embodiments, the first node may comprise at least one first sensor for determining when the first node is at each of the plurality of locations and at least one second sensor for measuring the network condition when the first node is at each of the plurality of locations. In some embodiments, a performance of the network in transferring data can be dependent on the expected network condition. In some embodiments, the expected network condition may be an expected range for the network condition. In some embodiments, the expected network condition may comprise any one or more of an expected signal strength, an expected bandwidth, an expected latency, an expected data transfer speed, and an expected packet loss.

In some embodiments, the scheduling referred to herein can be performed during execution of one or more tasks at one or more of the first node and the second node. In some embodiments, scheduling the data transfer may comprise selecting a schedule for the data transfer from a plurality of predefined schedules. More specifically, the entity 10 (e.g. the processing circuitry 12 of the entity 10) may be configured to select a schedule for the data transfer according to some embodiments. In some embodiments, selecting the schedule for the data transfer from the plurality of predefined schedules can comprise, for each of the plurality of predefined schedules, estimating a time at which the data transfer is expected to be completed according to the predefined schedule based on the expected network condition in the network at each of the plurality of locations and selecting the schedule from the plurality of predefined schedules for which the earliest time is estimated. More specifically, the entity 10 (e.g. the processing circuitry 12 of the entity 10) may be configured to perform this estimation and selection according to some embodiments. In some embodiments, selecting the schedule for the data transfer from the plurality of predefined schedules can comprise, for each of the plurality of predefined schedules, estimating a time expected to complete the data transfer according to the predefined schedule based on the expected network condition in the network at each of the plurality of locations and selecting the schedule from the plurality of predefined schedules for which the estimated time is the shortest. More specifically, the entity 10 (e.g. the processing circuitry 12 of the entity 10) may be configured to perform this estimation and selection according to some embodiments.

Although not illustrated in FIG. 3, in some embodiments, the method may comprise, rescheduling the data transfer between the first node and the second node in response to a change in the expected network condition in the network at one or more of the plurality of locations. More specifically, the entity 10 (e.g. the processing circuitry 12 of the entity 10) may reschedule the data transfer according to some embodiments. The rescheduling can be based on the expected network condition in the network at each of a plurality of locations following the change. In some embodiments, the rescheduling may take into account any data already transferred. For example, in embodiments where the data transfer is for executing a set of tasks of an application, the rescheduling may take into account any tasks already completed and optionally also an ordering and/or dependency of the tasks. This information can be used to re-organise the set of tasks and can avoid losing the flow logic.

In some embodiments, rescheduling the data transfer can comprise reselecting a schedule for the data transfer from the plurality of predefined schedules. More specifically, the entity 10 (e.g. the processing circuitry 12 of the entity 10) may be configured to reselect a schedule for the data transfer according to some embodiments. In some embodiments, reselecting the schedule for the data transfer from the plurality of predefined schedules can comprise, for each of the plurality of predefined schedules, estimating a time at which the data transfer is expected to be completed according to the predefined schedule based on the expected network condition in the network at each of the plurality of locations following the change and selecting the schedule from the plurality of predefined schedules for which the earliest time is estimated. More specifically, the entity 10 (e.g. the processing circuitry 12 of the entity 10) may be configured to perform this estimation and selection according to some embodiments. In some embodiments, reselecting the schedule for the data transfer from the plurality of predefined schedules can comprise, for each of the plurality of predefined schedules, estimating a time expected to complete the data transfer according to the predefined schedule based on the expected network condition in the network at each of the plurality of locations following the change and selecting the schedule from the plurality of predefined schedules for which the estimated time is the shortest. More specifically, the entity 10 (e.g. the processing circuitry 12 of the entity 10) may be configured to perform this estimation and selection according to some embodiments.

In some embodiments, each of the plurality of predefined schedules may be generated based on information about the data to be transferred. In some embodiments, the information about the data to be transferred can comprise information indicative of any one or more of a node on which the data is to be used, a dependency between the data, and a computation requirement for using of the data.

In some embodiments, scheduling the data transfer may comprise delaying (or deferring) the data transfer until the first node reaches a location from the plurality of locations at which the expected network condition is most favourable according to a pre-set criterion. More specifically, the entity 10 (e.g. the processing circuitry 12 of the entity 10) may be configured to delay the data transfer according to some embodiments. In some embodiments, the data transfer may be delayed (or deferred) in a switching scheme. In some embodiments, for example, the data transfer may be replaced with another data transfer.

In some embodiments, if the expected network condition at a first location of the plurality of locations along the expected path of the first node is more favourable than an expected network condition at a second location of a plurality of locations along an expected path of a third node, the data transfer between the first node and the second node may be scheduled with a higher priority than a data transfer between the third node and the second node at a time that the first node is expected to be at the first location and the third node is expected to be at the second location. In some embodiments, if the expected network condition at the first location is less favourable than the expected network condition at the second location, the data transfer between the first node and the second node may be scheduled with a lower priority than the data transfer between the third node and the second node at the time that the first node is expected to be at the first location and the third node is expected to be at the second location.

Although not illustrated in FIG. 3, in some embodiments, the method may comprise coordinating the scheduling of the data transfer between the first node and the second node with the scheduling of a data transfer between at least one other pair of nodes.

The technique described herein provides network-aware scheduling (NAS). A NAS architecture is also described herein. The technique and architecture described herein can be for applications, such as artificial intelligence or machine learning (AI/ML) applications, fog or edge applications, AI/ML fog or edge applications, or any other types of applications. The technique and architecture described herein can observe the state of the network, predict a future state of the network, and speculatively revise a schedule (e.g. a task execution schedule) to maximise performance in the network. The technique and architecture described herein can also employ a scalability concept, where certain data transfer (e.g. for task execution) is deferred. For example, it may be that high data transfers are deferred when the first node is in a low network zone.

In some embodiments, expected resource graph configurations can be used to create a list of possible schedules for executing on a directed acyclic graph (DAG), e.g. at the edge of the network. As the network conditions change, different schedules among the plurality of predefined (e.g. precomputed) schedules may become the optimum schedule, e.g. for a minimum time. In some embodiments, a (e.g. runtime) schedule switcher can be deployed to switch to the optimum schedule as the data transfer (e.g. for task execution) proceeds. The optimum schedule can be selected based on the network condition, so as to minimise a time for the data transfer and thus, for example, a minimum application execution time. The technique and architecture described herein can provide improved performance and capabilities (e.g. to an application, such as an AI/ML application) from both an end-user and a service provide perspective. This can include improved data speed, data quality, latency, and reliability.

The technique described herein involves scheduling a data transfer between a first node and a second node in a network, where the first node is a mobile node, and the scheduling is based on an expected network condition in the network at each of a plurality of locations along an expected path of the first node in the network. Thus, the technique described herein considers mobility as well as variations in network conditions, such as variations in wireless network conditions in the (e.g. 5G) network.

The technique described herein can be useful in the case of applications that run in a mobile environment with varying network conditions, while the first node is on the move.

The technique described herein considers the implications of dynamically changing network conditions on the data transfer, such as a data transfer in the execution of an application. The technique described herein can minimise data transfer time and thus, for example, application execution time for an end-user. For example, data transfer time can be minimised by avoiding or lessening a situation where the data transfer is carried out over a weak network link and thus where a task waits on such a data transfer.

The technique described herein can aid a network operator to serve a network transfer request, e.g. in an application specific manner. For example, the network operator can provide a service to re-prioritise tasks of an application that may benefit the application and/or the provider of the application. The technique described herein can help to reduce a total energy consumption of an application in completing its tasks. A fastest data transfer and thus fastest task completion time can be achieved a network condition is favourable.

In network slicing, with software defined networking and network function virtualisation, there exists a concept of running multiple logical networks as virtual independent business operations on a common physical infrastructure in an efficient and economical way. The technique described herein can be used as an integrated part of a network slice, such as a network slice dedicated to autonomous vehicles and/or other operations. The technique described herein help to improve quality of service (QoS) and quality of experience (QoE) in a network slice, such as for vehicle-to-vehicle (V2V) and vehicle-to-everything (V2X) communication. This can be especially valuable for continuity of service when a mobile node moves between different operator networks (i.e. when the mobile node is roaming).

In some embodiments of the technique described herein, edge computing can be used. For example, for a given endpoint layer, workload (such as a task of an application) may be offloaded to the edge of the network. This may be implemented when a network condition is favourable. In some embodiments, edge computing may be used only if a transmission overhead is smaller than local computation.

The technique described herein can be useful in the case of connected vehicles. A connected vehicle is a vehicle that is capable of connecting over a network to one or more (e.g. nearby) devices. A modern connected vehicle can require an extremely versatile network that can simultaneously deliver multiple functions, such as high throughout, ultra reliable and low latency communications (URLLC) for assisted driving, data gathering and analysis, sensors and device-to-device (D2D) communication, and/or other functions. In an example, a smart vehicle running an application may capture data from the vehicle and upload that data to an edge server for training a machine learning (e.g. neural network, NN) model. The trained machine learning model can be downloaded into the vehicle to provide it with intelligence, which can be context specific (e.g. sensitive to the data captured). The vehicle can either use an older machine learning (e.g. NN) model or a newer machine learning (e.g. NN) model. The use of a newer machine learning model involves uploading the captured data and downloading the trained machine learning model, which can incur a significant transmission overhead.

It can therefore be useful in this situation and many other situations to employ a scheduling strategy. A scheduling strategy (e.g. in edge computing) can be implemented based on graph theory. This can, for example, be useful when scheduling a data transfer for an application. In this example, the graph can represent an application. Specifically, each node in the graph can represent an application component and each edge in the graph can represent a communication between different application components. The application components may be running at different locations. In another example, each node in the graph can represent a (e.g. computing) resource, such as a server, and each edge in the graph can represent a relationship between resources. In this way, a scheduling problem can be transferred to a mapping problem between resource nodes and applications. The tasks of an application can be represented by a directed acyclic graph (DAG).

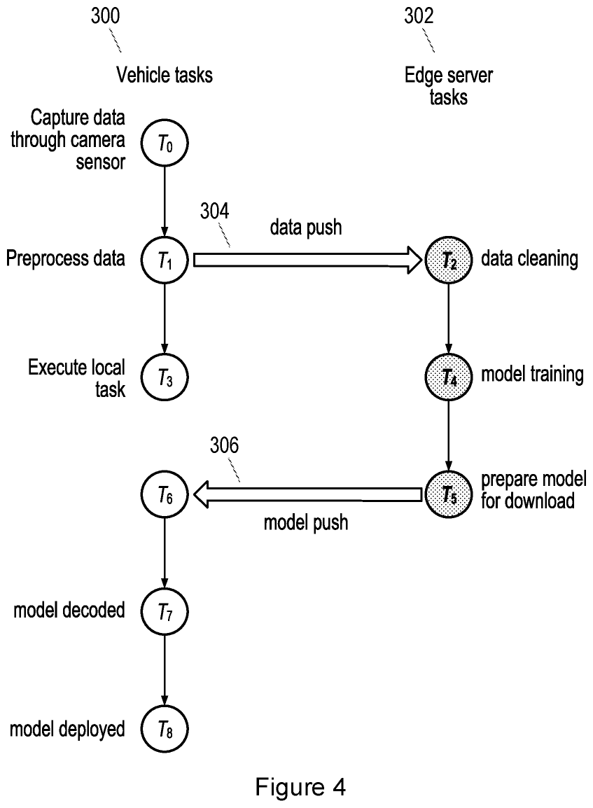

FIG. 4 illustrates an example of a such a DAG. As shown in FIG. 4, the tasks of an application are split into tasks 300 that are performed at a first node (which is a mobile node) and tasks 302 that are performed at a second node. In the example illustrated in FIG. 4, the first node is a vehicle and the second node is an edge server. However, it will be understood that the description applies to any other types of nodes.

As shown by the double arrows in FIG. 4, there is a data transfer 304 from the vehicle to the edge server and a data transfer 306 from the edge server to the vehicle. These data transfers use a (e.g. 5G) network link. As shown by the single arrows in FIG. 4, there are also data transfers within the vehicle and data transfers within the edge server. These data transfers do not use a (e.g. 5G) network link.

As illustrated in the DAG of FIG. 4, the vehicle can run a variety of different tasks, such as capturing data through cameras, pre-processing data, executing a local task, decoding a machine learning model received from the edge server, and deploying the machine learning model. Similarly, the edge server can also run a variety of different tasks, such as data cleaning (which can be another level of pre-processing on data exported by the vehicle), machine learning model training, and packaging of the machine learning model for pushing it to the vehicle.

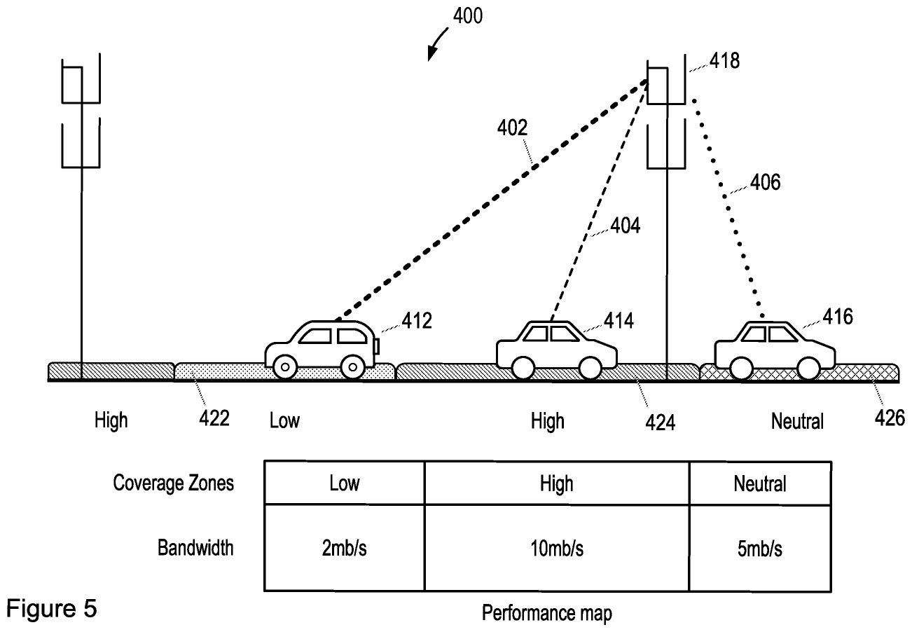

FIG. 5 illustrates an example network 400. As illustrated in FIG. 5, the network 400 comprises a first node 414 and a second node 418. As illustrated in FIG. 5, there is a data transfer between the first node 414 and a second node 418. The first node 414 is a mobile node and, in this example, is a vehicle or smart vehicle (e.g. a car). However, it will be understood that the first node 414 may be any other type of mobile node, such as any of those mentioned earlier. The second node 418 in this example is a server (e.g. an edge server). However, it will be understood that the second node 418 may be any other type of node, such as any of those mentioned earlier. As illustrated in FIG. 5, in some embodiments, the network 400 can comprise at least one other node, such as a third node 412, a fourth node 416, and/or any other number of nodes. In this example, the third node 412 and the fourth node 416 are mobile nodes or, more specifically, vehicles (e.g. cars). However, it will be understood that the third node 412 and the fourth node 416 may be any other type of mobile node, such as any of those mentioned earlier in respect of the first node 414.

As illustrated in FIG. 5, there is a data transfer 402 between the third node 412 and the second node 418, and a data transfer 406 between the fourth node 416 and the second node 418. The method described herein is for scheduling the data transfer 404 between the first node 414 and the second node 418 in the network 400, the data transfer 402 between the third node 412 and the second node 418 in the network 400, and/or the data transfer 406 between the fourth node 416 and the second node 418 in the network 400. In the manner described herein, the data transfer(s) are scheduled based on an expected network condition 424, 422, 426 in the network 400 at each of a plurality of locations along an expected path of the mobile node 414, 412, 416 in the network.

Any one or more of the first node 414, third node 412 and fourth node 416 illustrated in FIG. 5 may be running an application, e.g. an AI/ML application. The first node 414, third node 412 and fourth node 416 can utilise the network 400 to transfer (e.g. upload) data to the second node 418. The first node 414, third node 412 and fourth node 416 can utilise the network 400 to transfer (e.g. download) data from the second node 418. This data can, for example, be a machine learning model and/or any other data. A data transfer can also be referred to as a data push.

Depending on their location, the first node 414, third node 412 and fourth node 416 illustrated in FIG. 5 can be in a region of the network having a certain network condition 424, 422, 426. For example, as illustrated in FIG. 5, depending on their location, the first node 414, third node 412 and fourth node 416 can be in a region of the network having a first (e.g. high) signal strength 424, a second (e.g. low) signal strength 422, or a third (e.g. neutral) signal strength 426. The signal strength 424, 422, 426 in a region of the network can, for example, depend on the network (e.g. radio) coverage in that region of the network.

In an example where any one or more of the first, third, and fourth nodes 414, 412, 416 are running an application, those nodes 414, 412, 416 have the option of either using an old machine learning model or requesting a new machine learning model. The new machine learning model can be a machine learning model that was generated and/or trained more recently than the old machine learning model. Similarly, the old machine learning model can be a machine learning model that was generated and/or trained less recently than the new machine learning model. In some cases, the old machine learning model can be a machine learning model that the node 414, 412, 416 has used before, whereas the new machine learning model can be a machine learning model that the node 414, 412, 416 has not used before. In some cases, it can be beneficial to pull a new machine learning model as this can avoid degradation in the decision making of a machine learning model that can occur over time.

In an example, the first, third, and fourth nodes 414, 412, 416 may currently be transferring (e.g. uploading) data that they have captured to the second node 418. The data can, for example, be camera feeds. The size of the data transferred may, for example, be 100 MB (megabytes). The bandwidth of the network 400 at the first (e.g. high) signal strength region 424, third (e.g. neutral) signal strength region 426, and second (e.g. low) signal strength region 422, may be 10 MB/s, 5 MB/s and 2 MB/s respectively. As illustrated in FIG. 5, in some embodiments, these network conditions can be represented in the form of a performance map.

If all of the first, third, and fourth nodes 414, 412, 416 are transferring (e.g. uploading) data to the second node 418 while in the second (e.g. low) signal strength 422 region, it will take them 50s each to transfer the data. The overall throughput in the second (e.g. low) signal strength 422 region will be low as it takes a longer time for all of the first, third, and fourth nodes 414, 412, 416 to complete their data transfer. Conversely, if all of the first, third, and fourth nodes 414, 412, 416 are transferring (e.g. uploading) data to the second node 418 while in the first (e.g. high) signal strength 424 region, it will take them 10s each to transfer the data. This results in a higher overall throughput as transfers are completed much faster.

Thus, for each of the first, third, and fourth nodes 414, 412, 416, it can be valuable to schedule the data transfer 404, 402, 406 between that node 414, 412, 416 and the second node 418 based on an expected network condition 424, 422, 426 in the network 400 at each of a plurality of locations along an expected path of that node 414, 412, 416 in the network 400. For example, in some embodiments, scheduling the data transfer can comprise delaying the data transfer 404, 402, 406 until the node 414, 412, 416 reaches a location from the plurality of locations at which the expected network condition 424, 422, 426 is most favourable according to a pre-set criterion. In the example illustrated in FIG. 5, the pre-set criterion may be a predefined signal strength. For example, a data transfer 404, 402, 406 may be deferred until the respective mobile node 414, 412, 416 has reached the first (e.g. high) signal strength 424 region.

In this way, the network throughput can be maximised. In some embodiments, an overall schedule may be implemented such that mobile nodes 414 in the first (e.g. high) signal strength 424 region have priority to use the network 400. This can be particularly beneficial when there are a large number of mobile nodes (e.g. on the road in the case of vehicles) at any given time.

The technique described herein provides a complete framework for network-aware scheduling. In some embodiments, this framework can combine different types of model and innovative scheduling processes that can handle situations in which a network condition (or state) can vary. In a more detailed example, the framework can combine different types of model (or system). The first model (or system) can be referred to as an architecture model and can describe how the components of the network-aware scheduling framework fit together. The second model (or system) can be referred to as an application model and can show the way applications are represented and distributed among the first node(s) and the second node in the network-aware scheduling framework. The third model (or system) can be referred to as a transmission model and can explain how the network is captured.

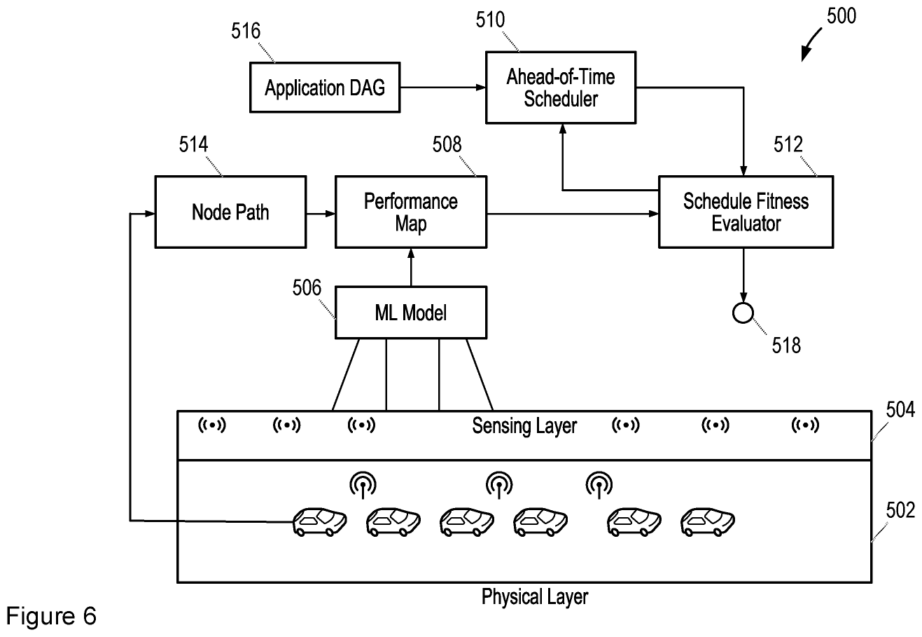

FIG. 6 illustrates the architecture model 500 referred to herein according to an embodiment. This architecture model 500 may also be referred to as a system. The architecture model 500 can comprise a plurality of components (e.g. modules) that each perform a function for the implementation of the technique described herein. For example, as illustrated in FIG. 6, the architecture model can comprise any one or more of a physical layer 502, a sensing layer 504, a machine learning model 506, a performance map 508, a scheduler 510 and a schedule evaluator 512. The entity 10 (or, more specifically, the processing circuitry 12 of the entity 10) described earlier can comprise the schedule evaluator 512 and optionally also the scheduler 510 according to some embodiments. The functions that may be performed by each of the components of the architecture model will now be described.

The physical layer 502 is made up of the physical world. The physical layer 502 can comprise the first node (e.g. an end device, such as a vehicle) referred to herein and the second node (e.g. a server, such as an edge server) referred to herein, and optionally also the third node referred to herein and/or the fourth node referred to herein. Any one or more of the first, second, third and fourth nodes referred to herein can be running one or more applications (e.g. an AI/ML application) or one or more services. The one or more applications are represented according to the application model, which will be described later. The first, third and fourth nodes referred to herein are mobile nodes and can be, for example, an end device (e.g. a vehicle) or any other type of mobile node such as any of those mentioned earlier. The second node referred to herein can be, for example, a server (e.g. edge server), a base station, or any other type of node such as any of those mentioned earlier. The physical layer can also comprise one or more (e.g. 5G) network links. The physical layer can also comprise one or more sensors.

The sensing layer 504 comprises one or more sensors. The one or more sensors can be placed in the physical layer 502. The one or more sensors can be configured to measure a network condition, such as a latency of accessing an application from the first, third and/or fourth nodes while the service is hosted at the second node. The one or more sensors can be configured to measure a network condition at each of a plurality of locations along an expected path of the first, third and/or fourth nodes in the network.

For example, measurements may be repeated for many node locations. The locations can, for example, be observed using a global positioning system (GPS) sensor. The measurements obtained from the one or more sensors can provide a dataset that quantifies the variation of network condition with node positions. That is, for selected coordinate positions that a mobile node has visited, measurements about the network condition at those points is acquired. As mentioned earlier, a performance of the network in transferring data can be dependent on the network condition. Thus, the network condition referred to herein can be indicative of the performance of the network in transferring data.

The machine learning model 506 can (e.g. continuously) acquire data from the sensing layer 504. More specifically, the machine learning model 506 can (e.g. continuously) observe a condition (e.g. state) of the network in the physical layer 502 through the sensing layer 504. The condition of the network is referred to herein as the network condition. The machine learning model 506 can be a neural network (NN) model or any other machine learning model. The machine learning model 506 can learn a performance map from the acquired data from the sensing layer 504. More specifically, the machine learning model 506 can be trained to analyse the network condition in the network to generate the performance map 508. Thus, the output of the machine learning model 506 can be such a performance map 508. The performance map 508 can be indicative of a predicted network condition (or performance) in the network. In some embodiments, the performance map 508 can be indicative of the predicted network condition in the network for a physical location and/or for a given time duration. A predicted network condition value may be an expected range (e.g. a high range for bandwidth can indicate that the network is likely to yield high data transfer rates). In some embodiments, at least two ranges may be used for the modelling of the network condition. For example, three ranges may be used, which can be referred to as “High”, “Neutral”, and “Low”. The machine learning model may (e.g. continuously) learn using the measurements that are made by the one or more sensors in the sensing layer.

As described earlier, the performance map 508 is generated by the machine learning model 506. The performance map 508 can comprise information indicative of predicted network conditions, e.g. network conditions predicted by the machine learning model 506. In some embodiments, the information indicative of the predicted network conditions can be a look-up table of the predicted network conditions. Thus, the performance map 508 may be in the form of a look-up table according to some embodiments. The predicted network conditions can be network conditions predicted for different times and/or for different regions in the network, such as any one or more (or all) regions of interest in the network. The regions of interest in the network can comprise a plurality of locations along an expected path of the first node in the network.

Thus, as illustrated in FIG. 6, an input to the performance map 508 can be the expected path (or trajectory) of the first node in the network according to some embodiments. That is, the performance map 508 can be used with the expected path of the first node. The performance map 508 itself can comprise information indicative of this expected path of the first node in the network. For example, in embodiments where the performance map 508 is in the form of a look-up table, the look-up table can comprise the information indicative of the expected path of the first node in the network. The performance map 508 can characterise the network condition at each of a plurality of locations along the expected path of the first node in the network. The performance map 508 can be a time-dependent data structure, since the predictions may change over time. The performance map 508 can cover all regions of interest to the mobile nodes that subscribe to the framework. For example, the performance map 508 may provide predictions for all points a mobile node can traverse.

The use of the performance map 508 may allow predictions to be acquired over different time scales. For example, the performance map 508 may allow the predicted network condition to be acquired for a predefined time period (e.g. for the next 100 milliseconds, the next 10 seconds, or any other predefined time period). As will described in more detail later, the schedule evaluator 512 can use the predictions provided by the performance map 508, such as over a predefined time window. In some embodiments, the schedule evaluator 512 may use the predictions provided by the performance map 508 over a long time window, which can be in contrast to a runtime schedule switcher that may use predictions over a short time window.

The scheduler 510 can also be referred to as an ahead-of-time (AoT) scheduler. The scheduler 510 can be a component that runs in the cloud according to some embodiments. The input to the scheduler 510 may be a data transfer model (or an application model) 516. The data transfer model (or application model) 516 can be in the form of a DAG according to some embodiments. For the data transfer model (or application model) 516, the scheduler 510 can generate one or more schedules for the data transfer (or, where the data transfer is for executing an application, for executing the application), e.g. on the networked system. In some embodiments, the scheduler 510 may generate a plurality of schedules for the data transfer. In some of these embodiments, the scheduler 510 may generate a list of schedules. The scheduler 510 can generate an exhaustive list of schedules according to some embodiments.

In some embodiments, a backtracking process may be used to generate all possible valid schedules for the data transfer model (or application model) 516. In some embodiments, in addition to outputting one or more schedules, the scheduler 510 (or a schedule switching module) may provide switching information indicative of points where the data transfer (e.g. the application execution) may switch from one schedule to another schedule. The switching information can be in the form of a matrix according to some embodiments. The matrix may also be referred to as a switching matrix or switch matrix. For example, as the network condition changes, the optimal schedule may change and thus the optimal schedule can always be used. The switching information that can be provided by the scheduler 510 can allow the runtime to change the schedule instead of sticking to a single schedule for the duration of a possibly long-running data transfer (e.g. application).

The scheduler 510 can feed the one or more schedules that it generates (using the application DAG) into the schedule evaluator 512. The schedule evaluator 512 can also be referred to as a schedule fitness evaluator (SFE). The schedule evaluator 512 can be configured to evaluate the one or more schedules generated by the scheduler 510.

The schedule evaluator 512 selects at least one schedule of the one or more generated schedules for the data transfer (or, where the data transfer is for executing an application, for executing the application). As explained earlier, the data transfer is a data transfer between the first node referred to herein (and/or any other mobile node referred to herein, such as the third node and/or the fourth node) and the second node referred to herein. In embodiments where the scheduler 510 generates a plurality (e.g. a list of) schedules for the data transfer, the schedule evaluator 512 may select one or more (e.g. a few) schedules from the plurality of possible schedules or all of the possible schedules.

While the scheduler 510 can generate an exhaustive list of schedules according to some embodiments, the schedule evaluator 512 may select at least one (e.g. better performing) schedule from this list. In some embodiments, the schedule evaluator 512 can (e.g. run the network-aware scheduling process described herein to) determine the optimum schedule for the data transfer. The output of the schedule evaluator 512 is thus at least one selected schedule (e.g. the optimum schedule) for the data transfer.

The performance map 508 can also be fed into the schedule evaluator 512. Thus, the schedule evaluator 512 can be configured to evaluate the one or more schedules along with the expected (e.g. value of the) network condition predicted by the performance map 508. For example, the schedule evaluator 512 may use expected (e.g. values of the) network conditions from the performance map 508 over future time intervals to select at least one schedule. In some embodiments, the schedule evaluator 512 may determine the optimum schedule for the data transfer given the network configurations by the performance map 508.

The schedule evaluator 512 can use the one or more schedules from the scheduler 510 and optionally also the network models from the performance map 508 to obtain at least one schedule that is to be deployed by the first node referred to herein (and/or any other mobile node referred to herein, such as the third node and/or the fourth node) and the second node referred to herein. Thus, the output 518 of the schedule evaluator 512 can be at least one schedule (e.g. the optimum schedule) for deployment in the network. The at least one selected schedule can be deployed by the first node referred to herein (and/or any other mobile node referred to herein, such as the third node and/or the fourth node) and the second node referred to herein. In some embodiments, the schedule evaluator 512 may be responsible for triggering the schedule switching if necessary. In some embodiments, the schedule evaluator 512 may run in the first node referred to herein (and/or any other mobile node referred to herein, such as the third node and/or the fourth node) and the second node, e.g. at runtime.

As illustrated in FIG. 6, in some embodiments, there may be a feedback loop from the schedule evaluator 512 and the scheduler 510. Thus, there can be a cyclic relationship between the scheduler 510 and the schedule evaluator 512 according to some embodiments. The feedback loop may provide the scheduler 510 with the at least one selected schedule, such as one or more (e.g. a subset of) optimum schedules, after evaluation. The one or more optimum schedules may be those that are found to be the best performing after evaluation. In some embodiments, the at least one schedule provided by the schedule evaluator 512 to the scheduler 510 can be used to obtain the switching information (e.g. matrix) mentioned earlier. For example, the switching information may be employed to enable a runtime scheduler to switch to an optimum (e.g. better performing) schedule at runtime, such as if there is an anticipated network change.

The data transfer model (or application model) 516 referred to herein can be modelled as a DAG according to some embodiments. For example, the nodes of the DAG may represent computations and the edges of the DAG may represent the data transfer (e.g. communication) and optionally also any precedence constraints. The data transfer model (or application model) 516 may thus also be referred to as a DAG model. An objective may be to optimally distribute the DAG across the second node referred to herein and any one or more of the first, third or fourth mobile nodes referred to herein, e.g. such that the time taken to complete the DAG execution (from start to finish) is minimised, i.e. such that the makespan for executing the DAG is minimised. In some embodiments, e.g. upon request, the DAG referred to herein may be used to generate (e.g. a list of) all tasks Tᵢ associated with an application to which the data transfer relates, their execution order E, their dependency as a weight attached to the edge as communication cost, or data required C_{i,i′} between one task Tᵢ and another task T_{i′}. In some embodiments, the DAG referred to herein can be used to provide the computation cost cᵢ of each task Tᵢ.

In some embodiments, the data transfer model (or application model) 516 may be described by a tuple, such as a two tuple. In an example where the data transfer is for executing an application, the application model 516 may be described by a two tuple G=(T, E), where T is a task set T (T₁, . . . , T_{N}) comprising different associated tasks of an application and E is a set of edges between tasks denoting the execution order and communication between two adjacent tasks, thus specifying their dependencies. In this example, an edge (i, i) between nodes i and i′ can represent that task Tᵢ is a predecessor of task T_{i′} and therefore task Tᵢ is to complete its execution before task T_{i′}. In the example DAG illustrated in FIG. 4, the tasks are executed on computational resources which can either be tasks 300 that are performed at the first node or tasks 302 that are performed at the second node. The inter-dependency among the different tasks of the application can be captured using the application model 516.

In some embodiments, a weight may be attached to each task. For example, the weight attached to each task Tᵢ may represent the computational requirement, denoted by cᵢ. The weight attached to each edge may represent the communication cost between tasks Tᵢ and T_{i′}, which is denoted as C_{i,i′}=data(Tᵢ, T_{i′}). The data transfer between two tasks may only be required when two tasks are executed on different computational resources.

The application model 516 may produce multiple ordering of the tasks according to some embodiments. For example, the application model 516 may be used to determine a different ordering of task instances to be deployed depending on the network condition, e.g. to minimise the execution time. In some embodiment, a batch mode for data transfers may be analysed and validated. These data transfers can be where one task has finished processing its input data and sends the result to the successor task for processing. The technique described herein can be generalised for stream processing, where there is a continuous flow of data between tasks. For example, this may be achieved by splitting the data into segments (or chunks), such as in the manner already used with hypertext transfer protocol (HTTP) live streaming (HLS). Thus, high quality segments may be delivered to the successor task when the predecessor task is transferring data in a high network region while low quality segments can be delivered when the transfer is performed in a low network region.

The transmission model referred to herein can be a model of the network. For example, the network may be modelled as having different network conditions, such as in the example shown in FIG. 5. Given the location of the first mobile node (e.g. edge device or vehicle), the performance map may show a plurality of different network regions, e.g. high, low and neutral network regions. The performance may, for example, indicate different communication bandwidth between the first mobile node and the second node (e.g. edge server) in the different regions of the network.

The average communication bandwidth among computational resources φᵢ and φᵢ′ in the network can be denoted as B_{φ}_{ᵢ}_{,φ}_{_{i′}} and the computational resource for executing tasks Tᵢ can be denoted as φᵢ. Then, the transmission time Γ_{i,i′} for transmitting a task from one resource φᵢ′ to another resource φᵢ in the network (e.g. at the edge of the network) may, for example, be given by the following equation:

$${Γ}_{i , {i}^{′}} = \{ \begin{matrix}\frac{{Γ}_{i , {i}^{′}}}{{B}_{{φ}_{i} , {φ}_{i}^{′}}} , if {φ}_{i} = {φ}_{i}^{′} \\ 0 , if {φ}_{i} = {φ}_{i}^{′}\end{matrix} \qquad ( 1 )$$

The above equation can be used to compute the transmission time if the task at the edge of the network is executing on different resources, i.e. where <φᵢ≠φᵢ′.

The communication links between tasks can be classified into three types, namely inter-transfer communication links, intra-transfer communication links, and non-transfer links. An inter-transfer communication link is a data transfer that occurs between two tasks such that they are executing on different resources (the first node or the second node). In this case, there is an execution dependency between the two tasks. The technique described herein can be particularly useful in respect of inter-transfer communication links since they incur a data transfer cost on the network and thus it is beneficial to take them into consideration when scheduling the tasks. In FIG. 4, the double arrows denote inter-transfer communication links.

An intra-transfer communication links is a data transfer that occurs between two tasks on the same resource or on the same resource type. For example, this can be where both tasks Tᵢ and T_{i′} are executed on the second node (or the first node). Task T_{i′} may be executed after the completion of task Tᵢ. In the case of an intra-transfer communication link, the data transfer cost can be assumed to be zero, since the data transfer does not have any implications on the network. In FIG. 4, the single arrows denote intra-transfer communication links.

A non-transfer link refers to tasks that do not have any data transfer between them. In this case, no edge exists between the tasks.

The scheduling strategy (e.g. the network-aware process and optionally also the switching process) described herein can optimise the utilisation of resources, reduce response time, improve energy efficiency, and improve the efficiency of data transfers and thus task processing. The scheduling strategy described herein can comprise coordination of data transfer (e.g. task execution) and resource between nodes, whilst also considering the heterogenous nature of the resources (e.g. computing resources).

The scheduling strategy described herein employs a network-aware process. In some embodiments, there may be two scheduling processes used, namely the network-aware process and a switching process. The scheduling process(es) can be incorporated into the architecture model referred to herein.

In some embodiments, the technique described herein may be started when the first node referred to herein (or any other mobile node referred to herein, such as the third node or the fourth node) accesses a backend service to which it has subscribed. The backend service can, for example, be a backend application service. If the backend is at a cloud server, the physical location of the first node does not need to be taken. Alternatively, if the backend is hosted at an edge server, the backend will be different depending on the location of the first node and thus the location of the first node may be taken into account. The backend application can be modelled using a DAG.

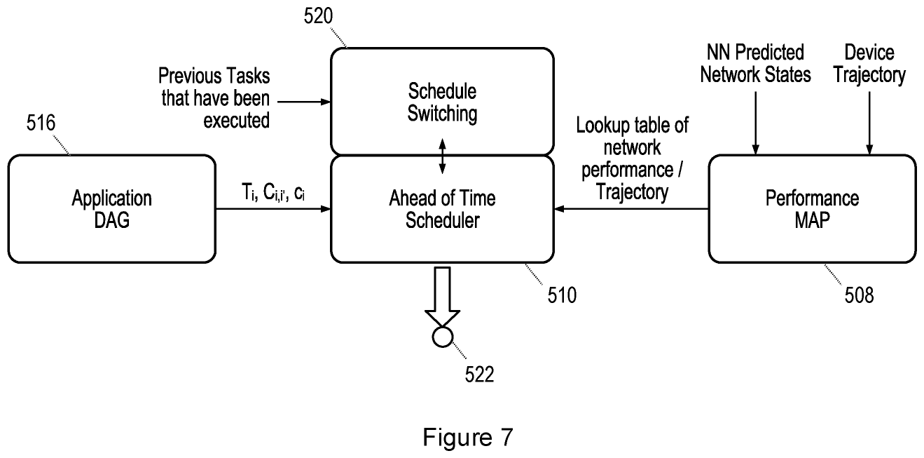

FIG. 7 illustrates an initial method that can be performed according to an embodiment of the technique described herein. More specifically, FIG. 7 illustrates an operation of the scheduler (or AoT scheduler) 510 mentioned earlier according to an embodiment.

As illustrated in FIG. 7, the input to the scheduler 510 is the data transfer model (or application model) 516, e.g. in the form of a DAG. In embodiments where the data transfer is for executing a set of tasks of an application, the scheduler 510 may ingest from the application model 516 (e.g. a list of) tasks Tᵢ associated with the application and optionally also any one or more of the execution order E of the tasks Tᵢ, the communication cost C_{i,i′} between one task Tᵢ and another (e.g. adjacent) task T_{i′}, and the computation cost cᵢ of each task Tᵢ. In some embodiments, the scheduler 510 may ingest the performance map 508 in the form of a look-up table. The performance map 508 can comprise the expected network conditions (or states) in the network predicted by the machine learning model and the information indicative of the expected path of the first node in the network.

The scheduler 510 can generate one or more schedules for executing the application. Thus, the output 522 of the scheduler 510 can be one or more schedules for executing the application. In some embodiments, the output 522 of the scheduler 510 can comprise a topological ordering of a plurality of schedules for executing the application.

In some embodiments, the output 522 of the scheduler 510 may comprise the switching matrix. Thus, for example, the scheduler 510 can provide one or more (e.g. all, or all valid) schedules for executing the application and optionally also switching information indicative of one or more points at which the execution can switch (or change) from one schedule to another schedule. This switching information may be in the form of a matrix, namely a switching matrix or switch matrix.

The switching information may be provided to the scheduler 510 by a schedule switching module 520. In some embodiments, the scheduler 510 may actually comprise the switching module 520. In other embodiments, the switching module 520 may be separate to the scheduler 510. The switching information may take into account previous tasks that have been executed. In some embodiments, a switching process may be employed to always deploy the optimum schedule, e.g. to deploy an efficient schedule at runtime. The application model 516 can employ a different ordering of tasks (or task instances). A continuously running application can deploy an optimal schedule at different points in time. The network conditions can subsequently change (e.g. at runtime) and thus a strategy of switching schedules (e.g. on-the-fly) can be beneficial. If there is no variation in access links, then a single ordering of the application model 516 may be deployed. However, since a network condition can vary at different points in time, the schedule that delivers the optimum (e.g. best) performance to the application at those different points in time can also vary.

In some embodiments, the output 522 of the scheduler 510 may be passed to the schedule evaluator 512, as shown in FIG. 6.

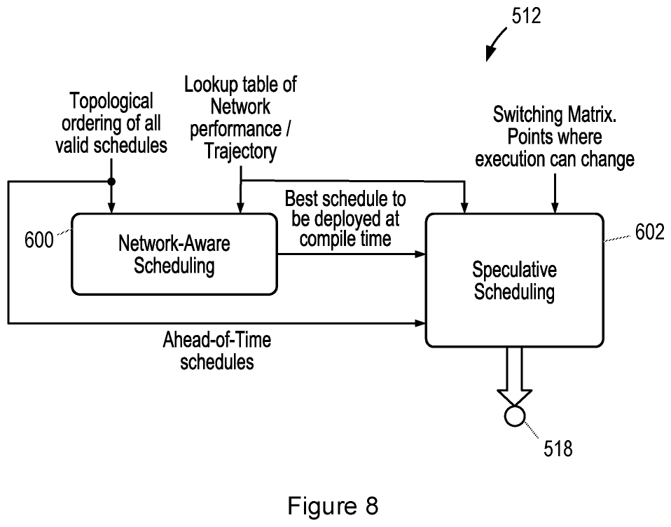

FIG. 8 illustrates a method that can be performed according to an embodiment of the technique described herein. More specifically, FIG. 8 illustrates an operation of the schedule evaluator (or SFE) 512 mentioned earlier according to an embodiment. The schedule evaluator 512 can implement the scheduling processes described herein. Specifically, the schedule evaluator 512 can implement the network-aware scheduling (NAS) process described herein and optionally also the speculative scheduling process described herein.

As illustrated in FIG. 8, in some embodiments, the schedule evaluator 512 may comprise a NAS module 600 for performing the NAS process described herein and a separate speculative scheduling module 602 for performing the speculative scheduling process described herein. However, it will be understood that the NAS process described herein and the speculative scheduling process described herein may be performed by the same module according to other embodiments.

Initially (e.g. at compile time), the schedule evaluator 512 acquires an expected network condition in the network and the expected path of the first node referred to herein in the network. The first node can be the node that will be running the application to which the data transfer relates. Although the method is described with reference to the first node, it will be understood that the method can equally apply to any other mobile node referred to herein, such as the third node and/or the fourth node.

The NAS process is that used to select an optimum (or best) schedule among one or more (e.g. a plurality of) available schedules to be deployed initially (e.g. at compile time) based on the expected network condition. The schedule evaluator 512 can run the NAS process and output a schedule to deploy to the computational resources, which are the first node referred to herein and the second node referred to herein. The schedule evaluator 512 evaluates the one or more schedules provided by the scheduler 510 for executing the application. For example, the scheduler 510 may provide a topological ordering of a plurality of schedules for executing the application that can be evaluated by the schedule evaluator 512. The schedule evaluator 512 may evaluate the one or more schedules against the network model that is the performance map 508 (e.g. in the form of a look-up table). The performance map 508 can comprise the expected network conditions (or states) in the network predicted by the machine learning model and the information indicative of the expected path of the first node in the network.

The schedule evaluator 512 can select the schedule that is optimum based on the expected network condition. In the case of more than one schedule being the optimum, any one of these schedules may be selected arbitrarily or randomly. The selection can be made at compile time according to some embodiments. The output 518 of the schedule evaluator 512 is the optimum schedule of the one or more schedules. For example, in some embodiments, the schedule evaluator 512 may compute a completion time for each of the one or more schedules. In these embodiments, the output 518 of the schedule evaluator 512 may be the schedule that has the shortest (or best) completion time.

In an example, if a task is the first task in the schedule, then an expected start time (EST) for the task is zero. Otherwise, for a task T′ that is not the first task in the schedule, the EST for the task T′ may be given by the following equation:

$${EST}_{( {T}_{i}^{′} )} = {EFT}_{( {T}_{i} )} + {Γ}_{i , {i}^{′}} \qquad ( 2 )$$

where i is a first resource in the network at which tasks can be performed, i′ is a second resource in the network at which tasks can be performed, EFT is an expected finish time of the preceding task T in the schedule at the first resource i (where the task T′ is expected to start), and Γ_{i,i′} is the transmission time of the preceding task T from the second resource i′ to the first resource i (e.g. at the edge of the network). Where the preceding task T is performed at a single resource (i.e. where the first resource i and second resource i′ are the same resource), the transmission time Γ_{i,i′} is zero and the expected start time for the task T′ is equal to the expected finish time EFT for the preceding task T.

The expected finish time (EFT) for the preceding task T may be given by the following equation:

$${EFT}_{( {T}_{i} )} = {EST}_{( {T}_{i} )} + {c}_{i} \qquad ( 3 )$$

where i is the first resource (where the preceding task T is expected to finish), EST is the expected start time for the preceding task T at the first resource i and cᵢ is the computation cost of each task at the first resource i.

The schedule completion times can be computed by taking the EST and EFT of each task in each schedule. The completion time of a schedule is the EFT of the last task in that schedule. In this way, the schedule with the shortest completion time can be selected. The task with the shortest completion time can be provided as the output of the process according to these embodiments. In the case of more than one schedule having the shortest completion time, ties may be broken arbitrarily. For example, any one of these schedules may be selected randomly.

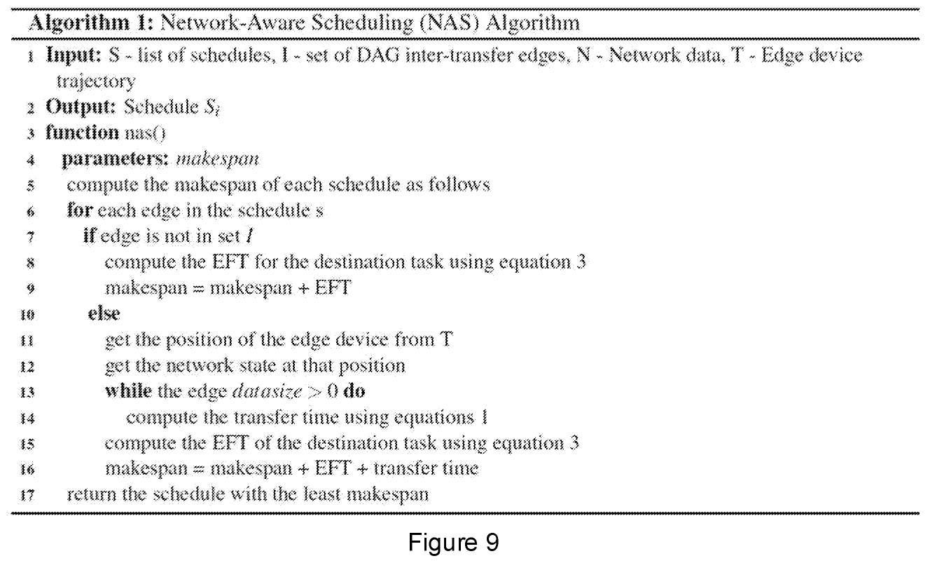

FIG. 9 illustrates a pseudocode example of the network-aware scheduling (NAS) process that can be used herein according to some embodiments. In the example illustrated in FIG. 9, the input to the NAS process is a list of schedules denoted by S, a set of DAG inter-transfer edges denoted by I, network data denoted by N, and a first node (e.g. edge device) path (or trajectory) denoted by T. The output to the NAS process in the example illustrated in FIG. 9 is a schedule denoted by Sᵢ. According to the example illustrated in FIG. 9, the makespan of each schedule is computed. The makespan of each schedule is the turnaround time for executing that schedule. The equations that are referred to in FIG. 9 as part of the computation of the makespan are those defined earlier. The schedule that is returned is the schedule with the shortest makespan.

Subsequently (e.g. at runtime), when the selected schedule is deployed, a change in the network condition may trigger a re-evaluation of the one or more schedule by the schedule evaluator 512. The change in the network condition may be detected when a network condition that is different from an earlier network condition (e.g. the network condition initially, such as at compile time) is anticipated. In some embodiments, a switching process may be deployed to determine which schedule(s) of the one or more schedules is to be re-evaluated, e.g. as some tasks may have already been executed. In some embodiments, a new schedule may consider the previously executed task(s) of the application model 516. In this way, a violation of a precedence constraint can be avoided.

The speculative scheduling process is that used to select an optimum (or best) schedule among one or more (e.g. a plurality of) available schedules to be deployed subsequently (e.g. at runtime) based on any expected change to the network condition. The optimum schedule can be selected in advance based on the predicted network condition. The schedule that is selected in the speculative scheduling process can be changed to reflect a change to the network condition. In some embodiments, the switching matrix can be used to change the selected schedule. The speculative schedule process can handle any one or more of the switching matrix, the optimum schedule anticipated by the NAS process, the performance map, and the current schedule provided by the scheduler 510. Any one or more of these four items can be exploited to select which schedule to deploy.

In some embodiments, if a network condition (or state) is predicted to change, the schedule evaluator 512 may evaluate the current schedule against one or more alternative schedules provided by the scheduler 510, e.g. using a switching matrix. The same selection criteria mentioned earlier (e.g. the shortest completion time) may be used to select the optimum schedule. If the network change prediction is correct, the newly selected schedule may be deployed. On the other hand, if there is no change to the network condition (or state), the current schedule may be used. For example, the application may be deployed with the current schedule. Either way, the performance delivered to the application can be maximised.

Thus, the NAS process can be employed to evaluate (e.g. partial tasks) in the schedules using the anticipated network state, and the optimum schedule (e.g. with the minimal completion time) can be selected for execution. This schedule can, for example, be executed initially (such as at compile time). The speculative scheduling process can be employed to handle a switch (e.g. using the switching matrix) to another newly optimum schedule (e.g. with the minimal completion time). The switch to this schedule can, for example, be performed subsequently (such as at runtime). Any output of the schedule evaluator 512 can be fed back to the schedule switching module 520 according to some embodiments.

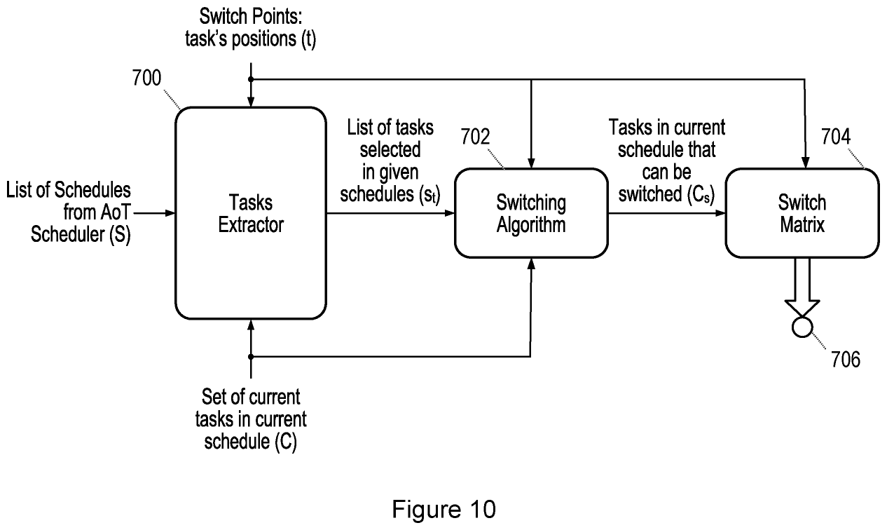

FIG. 10 illustrates a method that can be performed according to an embodiment of the technique described herein. More specifically, FIG. 10 illustrates a schedule switching process according to an embodiment. The switching process can be executed in the schedule switching module 520. The switching process can be used to determine one or more schedules to which a current schedule can be switched. The switching process can be run at runtime according to some embodiments. In some embodiments, in order to save time, the scheduler 510 may be run ahead of time. In some of these embodiments, it may only be necessary to perform a look-up of the switching information (e.g. on the switching matrix) when a change in the network condition is detected.

As illustrated in FIG. 10, the switching process can comprise ingesting one or more alternative schedules (S) along with a currently running schedule (C). The switching process can also ingest one or more switch points (t) at which the currently running schedule can be switched to an alternative schedule. A switch point can be a point in the task ordering where a schedule can be switched. At block 700 of FIG. 10, the switching process can comprise selecting which of the one or more alternative schedules the current schedule can be switched to, e.g. at runtime. The one or more alternative schedules that are selected (sₜ) may have the same subset of tasks as the current schedule that is running up until the relevant switch point. At block 702 of FIG. 10, the switching process can comprise selecting which tasks in the current schedule can be switched. In some embodiments, the switching process may take into account tasks that have already been executed up until the relevant switch point.

At block 704 of FIG. 10, the switching process can comprise generating switching information that is indicative of the one or more alternative schedules to which the current schedule can be switched at a different switch point. The information generated may be in the form of a matrix, namely a switching matrix or switch matrix. The switching matrix can show the different schedule(s) to which the current schedule can be switched at a different switch point. Thus, the output 706 of the switching process can be the switching information (e.g. the switching matrix).

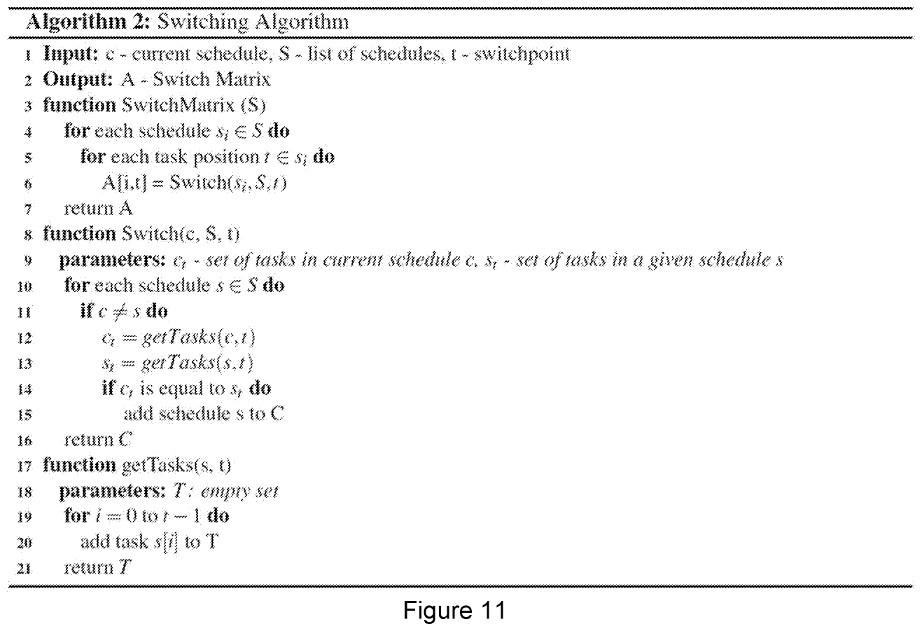

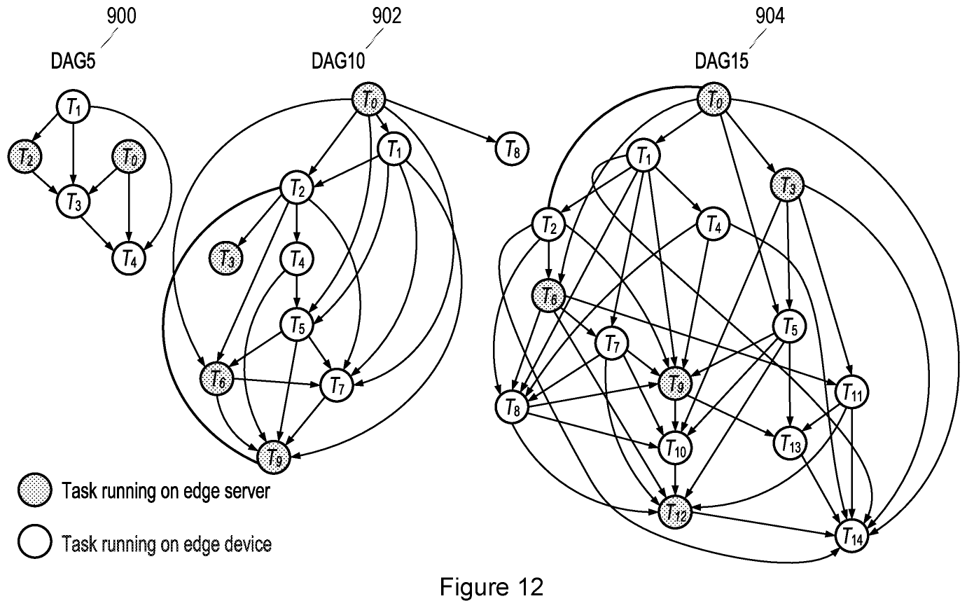

FIG. 11 illustrates a pseudocode example of the switching process that can be used herein according to some embodiments. In the example illustrated in FIG. 11, the input to the switching process is the current schedule denoted by c, a list of schedules denoted by S, a switch point denoted by t. The output to the switching process in the example illustrated in FIG. 11 is a switch matrix denoted by A.

An example of the technique described herein will now be described with reference to a particular use case. However, it will be understood that the technique described herein can also apply to many other use cases.

In the example, the technique begins with a request to run an application. For example, a user of the first node (e.g. a smart vehicle, an edge device, or any other type of first node) may request to run a backend application located in the cloud. The application is modelled as a DAG and can provide a list of tasks and optionally also their ordering, connections, list of computed resources, and their communication requirement needed to run the application. The communication requirement may be, for example, a requirement that processing is to be performed at the first node or at the second node (e.g. an edge server or any other type of second node).

A performance map can be generated next. The performance map generation can comprise predicting a network condition (e.g. a network link state or quality) using a machine learning model (e.g. a neural network). For example, the machine learning model can acquire data from the sensor layer mentioned earlier and analyse that data to predict the network condition. The performance map generation can comprise acquiring an estimated path of the first node (and any other mobile nodes, such as the third node and/or fourth node). In the case of an estimated path of multiple mobile nodes being acquired, the estimated paths of these mobile nodes may be aggregated. A path of a mobile node can be acquired, for example, using the speed of the mobile node and the (e.g. GPS) position of the mobile node. The path of a mobile node can be acquired from the sensor layer mentioned earlier. The performance map can then be generated using the predicted network condition that is output from the machine learning model and the estimated path of the first node (and any other mobile nodes). For example, the performance map be generated as a look-up table. The performance map can characterise the network condition at each of a plurality of locations along the expected path of the first node (and any other mobile nodes) in the network.

Next, one or more schedules or topologically valid schedules may be generated. For example, a list of schedules or a list of topologically valid schedules may be generated. The one or more schedules can be generated using the output of the DAG. The scheduler mentioned earlier may generate the one or more schedules. Next, switching information (e.g. a switching matrix) may be determined. The performance may and optionally also the previously executed tasks may be ingested by the switching process mentioned earlier to estimate one or more switching points where a current schedule can be switched to an alternative schedule and this can be represented by the switching information.

The optimum (or best) schedule may then be deployed. In more detail, the NAS process described earlier can be performed. The network condition from the performance map and the one or more schedules (e.g. output from the scheduler) can be used to perform the NAS process. The schedule evaluator (or schedule fitness evaluator) mentioned earlier may perform the NAS process. The NAS process can involve the network-aware scheduling of tasks. The NAS process can comprise ingesting the performance map and the one or more schedules (e.g. output from the scheduler). The one or more schedules may be topologically ordered and/or can include all valid schedules. The NAS process can comprise selecting the optimum (or best) schedule to be deployed initially, e.g. at compile time. The optimum schedule may, for example, be the schedule with the most favourable communication to computational ratio (CCR).

The speculative scheduling process described earlier can also be performed. The speculative scheduling process can involve the speculative scheduling of tasks. The speculative scheduling process can comprise ingesting the output of the NAS process, the one or more schedules (e.g. output from the scheduler) and this may include their topological ordering if relevant, the switching information (e.g. switching matrix) estimated by the switching process and the network condition obtained from the performance map. The speculative scheduling process can comprise selecting the optimum (or best) schedule to be deployed subsequently, e.g. at run time, according to the network condition observed in the performance map. The selected schedule can be deployed either at the first node (or any other mobile node) referred to herein and/or at the second node referred to herein. The selected schedule may be updated depending on the network condition.

In order to demonstrate the benefits of the technique described herein, experiments have been run and simulation results have been acquired for some test cases. To evaluate the effectiveness of the proposed NAS process described herein, two different metrics were used. The first metric is the makespan and the second metric is the cost, both of which have been seen to be reduced by way of the NAS process described herein. The makespan is the turnaround time for executing an application DAG, which can be beneficial from a client perspective. A shorter makespan can ensure the application has a faster response time. The cost is the money that needs to be invested by the service provider to execute the application. A lower data cost paid to support the service provided to the client allows the provider to make a better return on profit.

FIG. 12 illustrates the DAGs 900, 902. 904 for the test cases. In each test case, there are a plurality of tasks. As illustrated in FIG. 12, the tasks are either running on the first node (e.g. an edge device) referred to herein or the second node (e.g. an edge server) referred to herein. The first DAG 900 comprises 5 nodes that each represent a task, the second DAG 902 comprises 10 nodes that each represent a task, and the third DAG 904 comprises 15 nodes that each represent a task. The first DAG 900 comprises 7 edges that each represent a data transfer, the second DAG 902 comprises 23 edges that each represent a data transfer, and the third DAG 904 comprises 47 edges that each represent a data transfer. The number of schedules generated for each DAG 900, 902, 904 are 3, 54 and 913 respectively.

The CCR of a DAG is the ratio of the average communication cost to the average computation cost for the DAG. The CCR measure indicates whether a DAG is communication intensive, computation-intensive, or balanced. The values of CCR used were {0.1, 1.0, 10}, where 0.1 indicates that a DAG is computationally intensive and communication is of low significance, 1 indicates a DAG that is balanced, and 10 indicates a DAG that is communication-intensive where the significance of the communication process is high. The simulation uses a defined execution time for each task obtained from a cloud workload distribution. The simulation also uses a taxi mobility dataset and a network bandwidth dataset.

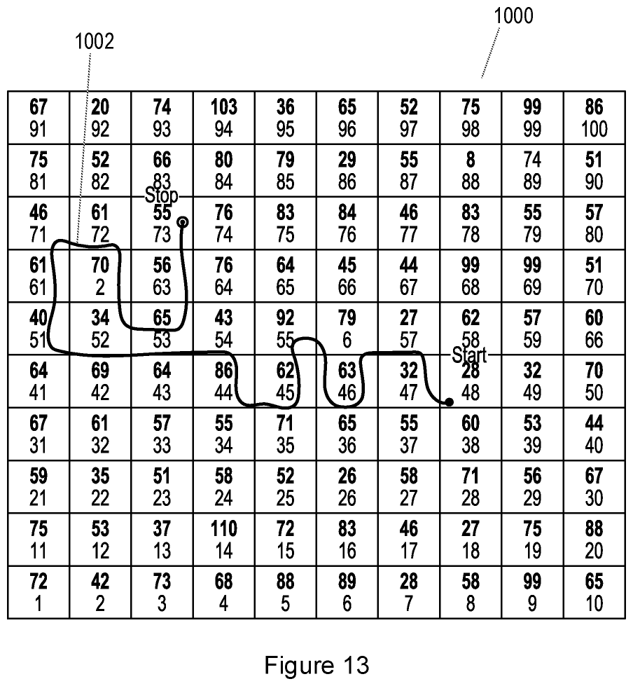

FIG. 13 illustrates a performance map 1000. The performance map 1000 comprises network data that is indicative of a network condition in different regions of the network and a sample first node (e.g. edge device or car) mobility path in the network, such as a smart city network. The first node is running an application in the network. The bold numbers in FIG. 13 represent the network data speed in megabits per second (Mbps) obtained at different locations in the network, while the other numbers represent the location of the first node. The line shows the expected path 1002 of the first node in the network. The location numbers are obtained from the longitude and latitude coordinates in the mobility dataset and are transposed into a grid with x and y coordinates. The grid coordinates are converted and stored as a one-dimensional array in the simulation.

The different DAG configurations were used to evaluate the network-aware scheduling (NAS) process described herein and a network-unaware scheduling (NUS) process used in existing techniques. The experiments were repeated 100 times and the experimental results were recorded. For the purpose of the experiment, the network-aware scheduling (NAS) process illustrated in FIG. 9 was used.

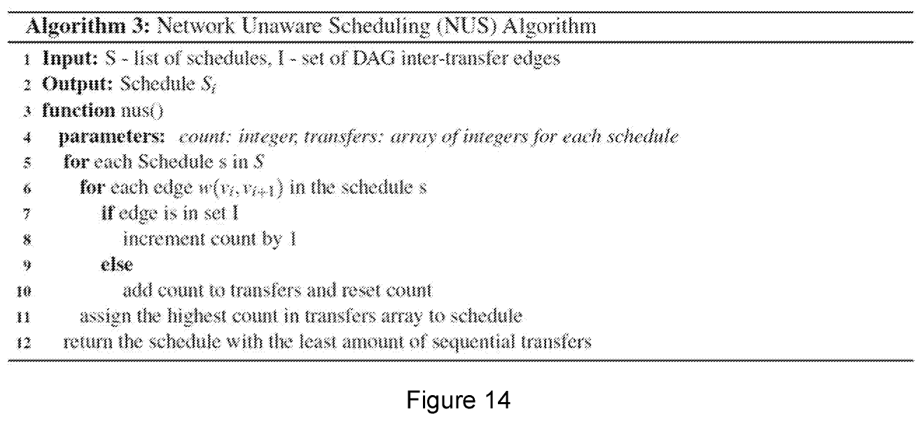

FIG. 14 illustrates the network-unaware scheduling (NUS) process that was used for the purpose of the experiment. The input to the NUS process is a list of schedules denoted by S and a set of DAG inter-transfer edges denoted by I. The output to the NUS process is a schedule denoted by Sᵢ. The schedule that is returned is the schedule with the fewest sequential data transfers.

Many 5G network use cases assume ubiquitous access and network services. For instance for V2X use cases, vehicles frequently cross boundaries and need to roam from one operator to another with different performance characteristics. Thus, the effect of changing network conditions on the NAS and NUS processes have been evaluated. This evaluation can be used to assess the performance of the switching process described herein. In the simulation, network changes were introduced by changing the network states at different time points and the performance of both NAS and NUS processes were observed. The NAS process speculatively changes schedules to the best schedule when it detects a network change, while the NUS process keeps running with the same schedule. The performance of both processes were compared using the configuration of the third DAG 904 illustrated in FIG. 12. The network changes were varied from 1 to 4. The process behaviour for different network change injection points was observed.

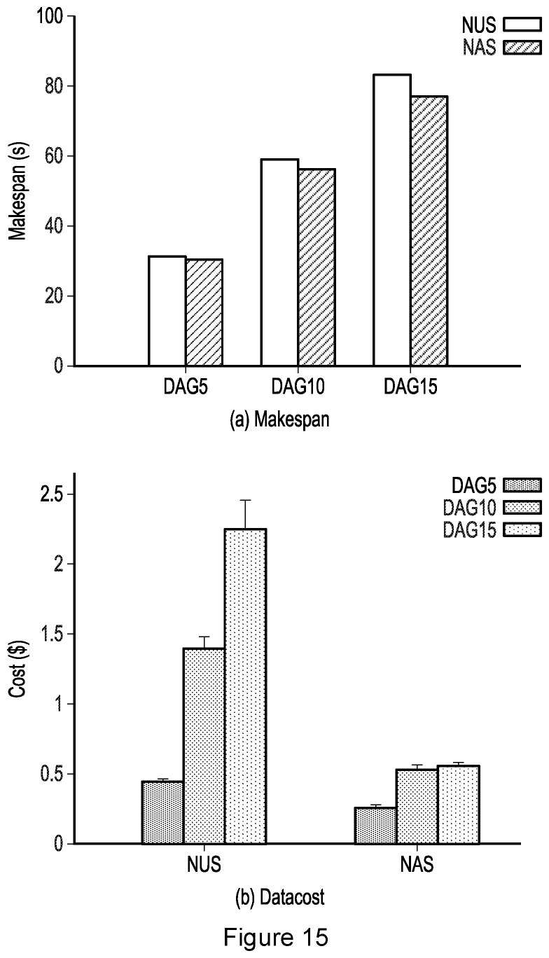

FIGS. 15-17 illustrate the experimental results of the simulation. It can be seen from these figures that the NAS process offers minimised execution time for the end user and lower resource cost for the service provider.

FIG. 15 illustrates the algorithm performance for the different DAG configurations illustrated in FIG. 12. In FIG. 15(a), the makespan of the NAS process is compared against the NUS process for the different DAG configurations. The NAS process provides better application performance across the three DAGs as it offers an improved execution time. The end-users benefit from faster response times compared to the NUS process. FIG. 15(b) shows the data cost incurred by the service provider in providing resources to execute the DAG configurations. The results show that the NAS process incurs lower data cost when compared to the NUS process. The NAS process schedules the application tasks by utilising the network conditions. That is, the task execution deferrals in the low network zones allow the service providers to use their resources to cater for task transfers in the high zone, thereby increasing their profit margins.

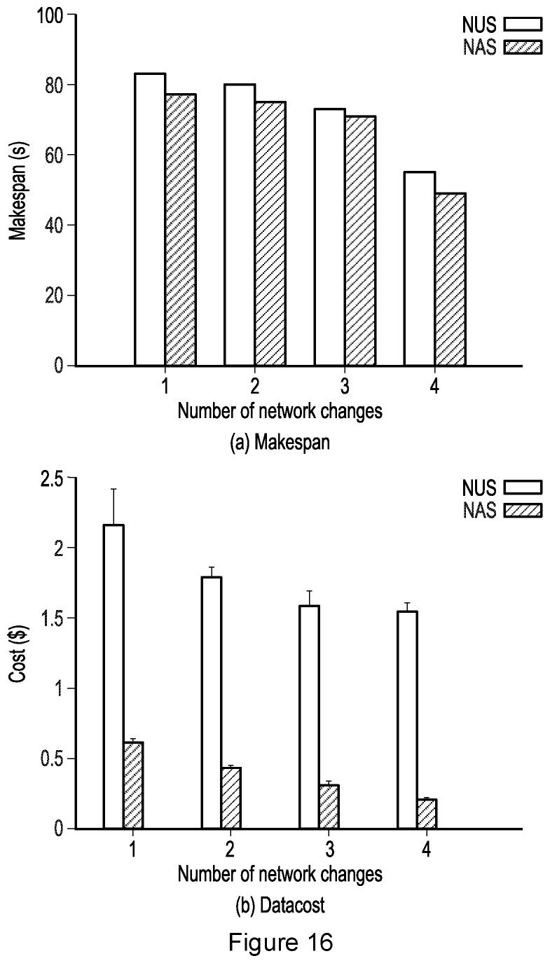

FIG. 16 illustrates the process performance for the configuration of the third DAG 904 illustrated in FIG. 12, with varying network conditions. As seen in FIG. 16(a), the NAS process provides a better makespan when compared to the NUS process and it also gives reduced data cost as shown in FIG. 16(b). Overall, it can be observed that, when the network changes from a good state to a bad state, no improvement is noticed in the schedule deployed as that schedule is the best schedule that can provide the best performance given that network condition. However, when the network changes from a bad state to a good state, then improvements to the performance of the application can be noticed in both processes. However, the switching process being deployed by the NAS process takes advantage of the better network conditions and provides better performance to the application in terms of reduced makespan and data cost.

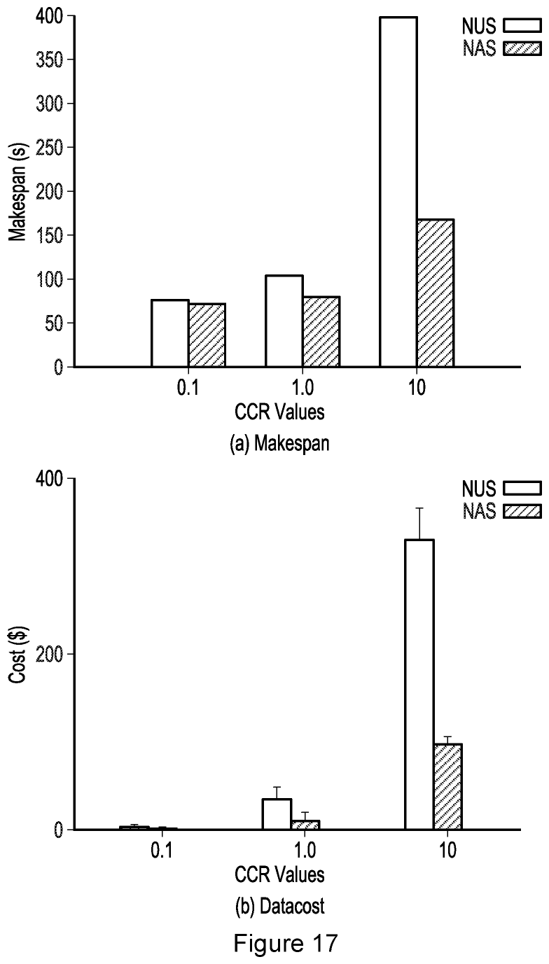

FIG. 17 illustrates the process performance for the configuration of the third DAG 904 illustrated in FIG. 12, with varying CCR values. The makespan and data cost for the different CCR values were evaluated for both the NAS and NUS processes. As seen in FIG. 17(a), the makespan for the computation-intensive DAG is lower than the communication-intensive DAG and the NAS process also provides a better makespan across the different values of CCR compared to the NUS process. In FIG. 17(b), the data cost is low for computation-intensive DAGs (CCR=0.1) but high for communication-intensive DAGs. The NAS process outperforms the NUS process for the different values of CCR. Generally, for computation-intensive DAGs, the makespan and data cost are close for both NAS and NUS processes. With small CCR values, the communication is less important than the computation. The improvement of the NAS process becomes significant for balanced (CCR=1) and communication-intensive (CCR=10) DAGs where the network awareness can benefit from the increase in the number of transmissions.

The technique described herein can be implemented in a distributed manner according to some embodiments. For example, the technique described herein can implemented across the cloud, the first node (and/or any other mobile node, e.g. smart vehicle, etc) referred to herein, and the second node (e.g. edge server, such as a RAN or other edge entity, etc) referred to herein.

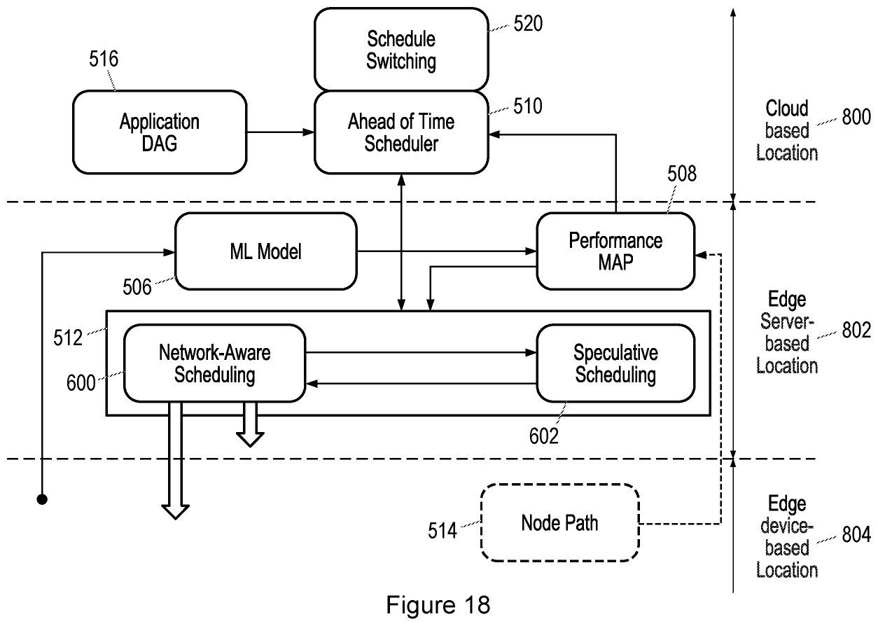

FIG. 18 illustrates the interaction between the components used to implement the technique described herein according to some embodiments. As illustrated in FIG. 18, in some embodiments, there can be three levels of deployment of the various components. These three levels can include a cloud based location 800, a second node (e.g. edge server) based location 802, and a first node (e.g. edge device) based location 804. The data transfer model (or application model, e.g. DAG) 516, the scheduler 510, and the schedule switching module 520 can be deployed in the cloud. The schedule switching module 520 can be separate to the scheduler 510 or comprised in the scheduler 510. The machine learning (e.g. NN) model 506, the performance map 508, and the schedule evaluator 512 (and thus the NAS scheduling process and the speculative scheduling process) can be deployed at the second node. In some embodiments, the schedule evaluator 512 may instead be deployed at the first node or may be deployed at both the first node and second node. The determination of the path of the first node 514 can be deployed at the first node.

An example will now be described to illustrated the functionalities according to the embodiment illustrated in FIG. 18. The process starts with the data transfer model (or application model) 516. For the purpose of the example, a vehicular application is assumed. However, it will be understood that the functionalities described are equally applicable to other situations. The application model 516 can define the task execution area (e.g. first node or second node), the dependency among different tasks of the application, and the computation requirement. This information is sent to the scheduler 510. The scheduler 510 generates a list of (e.g. all valid) schedules and switching information (e.g. a switching matrix) that specifies the switch points. The switching information may be provided to the scheduler 510 by the schedule switching module 520.

The schedules are the (e.g. long-term) predictions provided by the scheduler 510. The machine learning model is used to predict the network condition (e.g. performance, link quality, etc). The prediction can be made as the machine learning model (e.g. continuously) observes the condition of the network. The machine learning model 506 may use distributed deep learning-based processes or any other machine learning processes to make the prediction. The machine learning model 506 creates the performance map 508. In this example, three ranges are used to model the network performance. These ranges are referred to as high, neutral, and low. The performance map 508 can be a look-up table. This performance map 508 can cover all regions of interest to the first node. The first node may be subscribed to the application. The performance map 508 can also provide (e.g. short term) predictions based on the expected path (e.g. trajectory) of the first node. The expected path of the first node can be collected at the first node.

The schedule evaluator 512 can comprise the NAS module 600 for performing the NAS process and the speculative schedule module 602 for performing the speculative scheduling process (or both processes may instead be performed by the same module).

The NAS module 600 works in coordination with the speculative schedule module 602 and the schedule switching module 520. The schedule evaluator 512 ingests the performance map and the scheduler 510 output to determine different ordering of task instances to be deployed, depending on the network conditions. This deployment can be intended to minimise the execution time using the switching information (e.g. switching matrix) provided by the schedule switching module 520. The schedule switching module 520 can use the list of current and past schedules to generate information (e.g. a matrix) highlighting the schedules that can be switched to at different switch point.

The output of the schedule evaluator 512 (which is illustrated by the double arrows from the NAS module 600 in FIG. 18) is the best schedule, which reflects any observed changes in the network condition, relative to the speculative scheduling module 602.

The best schedule may be the schedule with the minimum completion time. The output of the schedule evaluator 512 can be sent to the first node and/or the second node, e.g. as needed by the application computation resources.

There is also provided a computer program comprising instructions which, when executed by processing circuitry (such as the processing circuitry 12 of the entity 10 described herein), cause the processing circuitry to perform at least part of the method described herein. There is provided a computer program product, embodied on a non-transitory machine-readable medium, comprising instructions which are executable by processing circuitry (such as the processing circuitry 12 of the entity 10 described herein) to cause the processing circuitry to perform at least part of the method described herein. There is provided a computer program product comprising a carrier containing instructions for causing processing circuitry (such as the processing circuitry 12 of the entity 10 described herein) to perform at least part of the method described herein. In some embodiments, the carrier can be any one of an electronic signal, an optical signal, an electromagnetic signal, an electrical signal, a radio signal, a microwave signal, or a computer-readable storage medium.

In some embodiments, the entity functionality described herein can be performed by hardware. Thus, in some embodiments, the entity 10 described herein can be a hardware entity. However, it will also be understood that optionally at least part or all of the entity functionality described herein can be virtualized. For example, the functions performed by the entity 10 described herein can be implemented in software running on generic hardware that is configured to orchestrate the entity functionality. Thus, in some embodiments, the entity 10 described herein can be a virtual entity. In some embodiments, at least part or all of the entity functionality described herein may be performed in a network enabled cloud. Thus, the method described herein can be realised as a cloud implementation according to some embodiments. The entity functionality described herein may all be at the same location or at least some of the functionality may be distributed, e.g. the entity functionality may be performed by one or more different entities.

It will be understood that at least some or all of the method steps described herein can be automated in some embodiments. That is, in some embodiments, at least some or all of the method steps described herein can be performed automatically. The method described herein can be a computer-implemented method.

Therefore, as described herein, there is provided an advantageous technique for scheduling a data transfer between a first node and a second node in a network. The best scheduling of the data transfer (e.g. for executing an application) can be ensured. The technique described herein can enable faster data transfers (and thus faster task completion time), reduced energy consumption, and improved load balancing. The technique described herein can be especially valuable during task scheduling in an edge computing environment. The technique described herein exploits the knowledge of the network condition (or state) characteristics to maximise the (e.g. application) performance. This can be particularly beneficial for URLLC use cases or any other use cases.

The execution time given to the network states, for the end-user and/or the service provider (e.g. in edge computing) can be minimised. In some embodiments, the technique described herein can output an overall schedule that dictates that mobile nodes (e.g. smart/connected vehicles, IoT devices, etc.) in high zones have priority to use the network. The resource cost for the service provider can be reduced by providing a service due to the rental costs of its resources. In some embodiments the technique described herein can maximise the throughput in the network by deferring data transfer (and/or its execution) and/or model transfer in low zones, e.g. until the first node has reached a high zone.

The technique described herein can enable the deployment of applications in a mobile environment with dynamically changing network conditions while the first node is on the move. By exploiting mobility and optionally also wireless network conditions (such as 5G), the data transfers can be smartly deployed in a low network zone. The schedules can be speculatively changed to the best schedule when a network change is detected.

The quality of service (QoS) and quality of experience (QoE) are in general expressed based on qualitative measures such as throughput, reliability, latency, execution cost and/or packet loss rate. This technique described herein can be deployed as a cloud based implementation, e.g. as a network slice or in a network slice, for improving or maintaining a superior granularity for a specific level of QoS and/or QoE (e.g. in V2V and V2X communication contexts). The technique described herein can efficiently and reasonably dispatch tasks of users according to the network quality according to some embodiments.

The technique described herein can be generalised to any type of tasks and activities in a network state aware way. The technique described herein can be used as a network-aware middleware framework where several processes (e.g. scheduling, synchronisation, resource allocation, timing, data capture, anomaly detection, and/or online model training) can be plugged in. Many applications may benefit from the technique described herein and these applications can include low latency applications, such as IoT analytics, machine learning, virtual reality, autonomous vehicles, etc. The technique described herein can support the new bandwidth and latency characteristics of these applications.

The technique described herein may be used as an intelligent transport service that manages data transfers in a network such that more data is pushed through the network when the network has high performance characteristics and less data is pushed through the network when the network has low performance characteristics. The technique described herein can act as an intelligent network uploads/downloads coordinator and can be scalable at the application level using efficient data transfer scheduling built into a (e.g. 5G) network-aware transport service. There is a need to reduce bandwidth costs of the IoT over long distances but, at the same time, real-time applications involving local processing and storage capabilities can be support by the technique described herein.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A computer-implemented method for scheduling a data transfer between a first node and a second node in a network, the first node being a mobile node, the method comprising:
scheduling the data transfer between the first node and the second node based on an expected network condition in the network at each of a plurality of locations along an expected path of the first node in the network.

2. The method as claimed in claim 1, wherein:
scheduling the data transfer comprises:
selecting a schedule for the data transfer from a plurality of predefined schedules.

3. The method as claimed in claim 2, wherein:
selecting the schedule for the data transfer from the plurality of predefined schedules comprises:
for each of the plurality of predefined schedules, estimating a time at which the data transfer is expected to be completed according to the predefined schedule based on the expected network condition in the network at each of the plurality of locations; and
selecting the schedule from the plurality of predefined schedules for which the earliest time is estimated.

4. The method as claimed in claim 2, wherein:
selecting the schedule for the data transfer from the plurality of predefined schedules comprises:
for each of the plurality of predefined schedules, estimating a time expected to complete the data transfer according to the predefined schedule based on the expected network condition in the network at each of the plurality of locations; and
selecting the schedule from the plurality of predefined schedules for which the estimated time is the shortest.

5. The method as claimed in claim 1, the method comprising:
in response to a change in the expected network condition in the network at one or more of the plurality of locations:
rescheduling the data transfer between the first node and the second node based on the expected network condition in the network at each of a plurality of locations following the change.

6. The method as claimed in claim 5, wherein:
rescheduling the data transfer comprises:
reselecting a schedule for the data transfer from the plurality of predefined schedules.

7. The method as claimed in claim 6, wherein:
reselecting the schedule for the data transfer from the plurality of predefined schedules comprises:
for each of the plurality of predefined schedules, estimating a time at which the data transfer is expected to be completed according to the predefined schedule based on the expected network condition in the network at each of the plurality of locations following the change; and
selecting the schedule from the plurality of predefined schedules for which the earliest time is estimated.

8. The method as claimed in claim 6, wherein:
reselecting the schedule for the data transfer from the plurality of predefined schedules comprises:
for each of the plurality of predefined schedules, estimating a time expected to complete the data transfer according to the predefined schedule based on the expected network condition in the network at each of the plurality of locations following the change; and
selecting the schedule from the plurality of predefined schedules for which the estimated time is the shortest.

9. The method as claimed in claim 5, wherein:
the rescheduling takes into account any data already transferred.

10. The method as claimed in claim 2, wherein:
each of the plurality of predefined schedules are generated based on information about the data to be transferred.

11. The method as claimed in claim 1, wherein:
scheduling the data transfer comprises:
delaying the data transfer until the first node reaches a location from the plurality of locations at which the expected network condition is most favourable according to a pre-set criterion.

12. The method as claimed in claim 1, wherein:
if the expected network condition at a first location of the plurality of locations along the expected path of the first node is more favourable than an expected network condition at a second location of a plurality of locations along an expected path of a third node:
scheduling the data transfer between the first node and the second node with a higher priority than a data transfer between the third node and the second node at a time that the first node is expected to be at the first location and the third node is expected to be at the second location; and
if the expected network condition at the first location is less favourable than the expected network condition at the second location:
scheduling the data transfer between the first node and the second node with a lower priority than the data transfer between the third node and the second node at the time that the first node is expected to be at the first location and the third node is expected to be at the second location.

13. The method as claimed in claim 1, wherein:
the expected network condition in the network at each of the plurality of locations is identified from a dataset; and
wherein, for each location of the plurality of locations, the dataset comprises a mapping between the location and the expected network condition at the location.

14. The method as claimed in claim 13, wherein:
the dataset is updated in response to a change in the expected network condition at any one or more of the plurality of locations.

15. The method as claimed in claim 1, the method comprising:
coordinating the scheduling of the data transfer between the first node and the second node with the scheduling of a data transfer between at least one other pair of nodes.

16. The method as claimed in claim 1, wherein:
the expected network condition at each of the plurality of locations is predicted based on historical measurements of the network condition at each of the plurality of locations.

17. The method as claimed in claim 1, wherein:
the first node is configured to measure the network condition at each of the plurality of locations and the first node comprises:
at least one first sensor for determining when the first node is at each of the plurality of locations; and
at least one second sensor for measuring the network condition when the first node is at each of the plurality of locations.

18. The method as claimed in am claim 1, wherein:
a performance of the network in transferring data is dependent on the expected network condition.

19. The method as claimed in claim 1, wherein:
the expected network condition is an expected range for the network condition.

20. The method as claimed in claim 1, wherein:
the expected network condition comprises any one or more of an expected signal strength, an expected bandwidth, an expected latency, an expected data transfer speed, and an expected packet loss.

21. The method as claimed in claim 1, wherein:
the data transfer is for executing, at the first node, a set of tasks of an application hosted by the second node.

22. The method as claimed in claim 1, wherein:
the data transfer comprises any one or more of:
at least one transmission of data from the first node towards the second node; and
at least one transmission of data from the second node towards the first node.

23. The method as claimed in claim 1, wherein:
one or both of the first node and the second node is an edge node of the network.

24. An entity comprising:
processing circuitry configured to schedule a data transfer between a first node and a second node in a network, the first node being a mobile node, the scheduling comprising:
scheduling the data transfer between the first node and the second node based on an expected network condition in the network at each of a plurality of locations along an expected path of the first node in the network.

25. A computer storage medium storing a computer program comprising instructions which, when executed by processing circuitry, cause the processing circuitry to
schedule a data transfer between a first node and a second node in a network, the first node being a mobile node, the scheduling comprising:
scheduling the data transfer between the first node and the second node based on an expected network condition in the network at each of a plurality of locations along an expected path of the first node in the network.
